(19) United States
(12) Patent Application Publication
(10) Pub. No.: US 2010/0068419 A1
(43) Pub. Date: Mar. 18, 2010

(54) RETARDATION FILM, A METHOD FOR PREPARING RETARDATION FILM AND POLARIZER COMPRISING THE RETARDATION FILM

(76) Inventors: Sin Young Kim, Daejeon (KR); Eun Kyung Kim, Daejeon (KR); Moon Soo Park, Daejeon (KR); Yong Il Cho, Daejeon (KR); Sung Ho Chun, Daejeon (KR); Hee Jean Lee, Daejeon (KR); Heon Kim, Daejeon (KR)

Correspondence Address: MCKENNA LONG & ALDRIDGE LLP, 1900 K STREET, NW, WASHINGTON, DC, 20006, US

(21) Appl. No.: 12/448,754

(22) PCT Filed: Apr. 23, 2008
(86) PCT No.: PCT/KR2008/002295

§ 371 Date: Jul. 6, 2009

(30) Foreign Application Priority Data
Apr. 23, 2007 (KR) 10-2007-0039588

(51) Int. Cl. C09K 19/04

(52) U.S. Cl. 428/1.23; 428/1.2

(57) ABSTRACT

There is provided a retardation film capable of adjusting an angle between a proceeding direction of a film and an optical axis of liquid crystal by employing an alignment layer formed of polymers including norbornene and improving thermal stability and photoreaction rate, a method for preparing the retardation film and a polarizer comprising the retardation film. The retardation film includes a substrate, an alignment layer formed on the substrate and made of polymers including norbornene, and an alignment layer fixing layer formed on the alignment layer and made of liquid crystal materials; the method for preparing a retardation film includes: forming a polymer layer by coating a substrate with a polymer solution including norbornene and drying the polymer solution, forming an alignment layer by irradiating the copolymer layer with linearly polarized ultraviolet rays in a predetermined direction relative to a proceeding direction of a film to give an orientation to the copolymer layer, forming a liquid crystal layer on the alignment layer by coating the alignment layer with a nematic liquid crystal solution and drying the nematic liquid crystal solution, and fixing the orientation of the liquid crystal layer by curing the liquid crystal layer; and the polarizer includes the retardation film and a polarizer film, both of which are stacked with each other. The retardation film has improved thermal stability and light reaction speed, and the retardation film whose optical axis has a desired orientation angle relative to a proceeding direction of the retardation film may be easily prepared through the irradiation of polarized ultraviolet rays.

### TECHNICAL FIELD

The present invention relates to a retardation film using a photoreactive polymer including norbornene, a method for preparing the retardation film and a polarizer comprising the retardation film, and more particularly, to a retardation film capable of adjusting an angel between a proceeding direction of a film and an optical axis of liquid crystal by employing a photoalignment layer formed of norbornene photoreactive polymer and improving thermal stability and photoreaction rate, a method for preparing the retardation film and a polarizer comprising the retardation film.

### BACKGROUND ART

Recently, a liquid crystal display has been increasingly used as a display device for portable information terminal apparatuses since it is light-weight and operates at low power consumption. Since portable electronic equipment is generally driven by a battery, it is important to reduce power consumption in the portable electronic equipment. Therefore, much attention has been paid to a transflective liquid crystal display device, among the portable liquid crystal display devices, that may operate at low power consumption, manufactured with thin and light-weight scale and shine brightly. The transflective liquid crystal display device includes at least one retardation film and polarizer. A retardation film having a desired birefringence was obtained in the art by uniaxially or biaxially stretching a polymer film to change the polarization axis of linear polarization or to change the linear polarization into circular polarization or elliptical polarization. However, the retardation film has so-called wavelength dispersion characteristics in which the phase difference of the retardation film is varied according to the wavelengths. Therefore, the retardation film has a problem that it does not obtain a sufficient polarization effect in a wavelength range rather than the certain wavelengths. In order to solve the problem, there has been proposed a method for stacking a plurality of stretched films so that optical axes of the stretched films can be crossed with each other. However, the method has a problem that a thickness of the retardation film are increased due to the use of a plurality of the stretched films, and it is very complicated to stack a plurality of the stretched films so that their optical axes can be crossed with each other, which leads to the low yield of the retardation film.

As an alternative to preparing a retardation film having good efficiency and improved physical properties as known in the prior art, Korean patent laid-open publication No. 2002-0068195 discloses a method for preparing a λ/4 retardation film in a continuous manner using a photoalignment layer made of polymethacrylate polymer, wherein the optical axis of liquid crystals has any predetermined angle in addition to a horizontal or vertical angle, relative to a proceeding direction of the λ/4 retardation film. However, the polymer disclosed in the patent literature has a problem that it is difficult for the retardation film to show sufficient alignment characteristics to a desired alignment level due to the low mobility although the polymer is exposed to the UV light for an extended time. This is why a photosensitizing group in the polymer is hard to promptly react to the irradiated polarization since the photosensitizing group is restricted to the main chain of the polymer. Therefore, the manufacturing process is very ineffective since it takes much time to polymerize the polymer into a network polymer, and the network polymer may not be used as a compensation film due to the insufficient alignment of the retardation film.

Korean patent laid-open publication Nos. 2006-0029068 and 2004-0102862 disclose a method of determining an orientation direction of liquid crystal in a predetermined direction by irradiating a liquid crystal material with polarized UV, the liquid crystal material being coated without a rubbing process. However, since the liquid crystal is cured only in an orientation direction of the liquid crystal when the liquid crystal molecules are oriented by irradiating a curable liquid crystal material with polarized UV as disclosed in the patents, and therefore surface strength of the liquid crystal may be reduced, and the liquid crystal may be easily deformed at the presence of external stimuli or heat due to the insufficient curing of the liquid crystal.

Japanese Patent Laid-open Publication No. 2006-133718 discloses a method manufacturing an alignment layer having good orientation shown on an acetylcellulose substrate, and an alignment layer wherein a photoreactive polymer having cinnamate group is made of photoalignment materials. However, in the Japanese Patent Laid-open Publication No. 2006-133718, the photoreactive polymer is commercially available from Rolic and its main chain includes vinyl group unlike that of one embodiment of the present invention. Here, the resulting retardation film includes a substrate composed only of acetylcellulose, and a liquid crystal polymer having a low solubility to conventional solvents, and therefore the retardation film has disadvantages in its use.

Japanese Patent Laid-open Publication No. 2006-513459 discloses that a film made of polynorbornene polymer is used as a protective film for upper/lower polarizers, and a −C-plate-combined film or a −C-plate compensation film as an additional film.

Also, Japanese Patent Laid-open Publication No. 2001-235622 discloses a retardation film having a positive uniaxial chain and a negative uniaxial chain, wherein the positive uniaxial chain is a norbornene chain, and the negative uniaxial chain is a styrene ring, a styrene-maleic anhydride copolymer, a styrene-crylonitrile copolymer and a styrene-methyl methacrylate copolymer.

However, the negative (−) C retardation films prepared according to the method described in Japanese Patent Laid-open Publication Nos. 2006-513459 and 2001-235622 have problems that the retardation films may not widely control their phase differences toward a thickness direction, and do not satisfy requirements regarding the slimness since their thicknesses are in a range of about 100 μm (micrometers) or more.

### DISCLOSURE OF INVENTION

### Technical Problem

Regardless of the various retardation films and the methods for preparing the same, there are required a retardation film capable of adjusting an angle between a proceeding direction of a film and an optical axis of liquid crystal and improving thermal stability and photoreaction rate, and a method for preparing the retardation film.

The present invention is designed to solve the problems of the prior art, and therefore it is an object of one embodiment of the present invention to provide a retardation film capable of adjusting an angle between a proceeding direction of a retardation film and an optical axis of liquid crystal.

Also, it is another object of one embodiment of the present invention to provide a retardation film whose thermal stability and light reaction speed are improved.

Also, it is still another object of one embodiment of the present invention to provide a method for preparing a retardation film capable of adjusting an angle between a proceeding direction of a retardation film and an optical axis of liquid crystal.

Also, it is still another object of one embodiment of the present invention to provide a method for preparing a retardation film whose thermal stability and light reaction speed are improved.

Furthermore, it is yet another object of one embodiment of the present invention to provide a polarizer including the retardation film according to one embodiment of the present invention.

### Technical Solution

According to an aspect of one embodiment of the present invention, there is provided a retardation film, including:

a substrate;

an alignment layer formed on the substrate and made of polymers having a polymerization unit derived from a compound represented by the following Formula 1; and

a liquid crystal layer formed on the alignment layer and made of nematic liquid crystal:

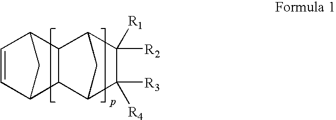

wherein, P is integer from 0 to 4,

at least one of R₁, R₂, R₃ and R₄ is a radical selected from the group consisting of the following Formulas a, b, and c, and

the rest of R₁, R₂, R₃, and R₄ are each independently selected from the group consisting of hydrogen; halogen; substituted or unsubstituted C1-20 alkyl, substituted or unsubstituted C2-20 alkenyl; substituted or unsubstituted C5-12 saturated or unsaturated cycloalkyl; substituted or unsubstituted C6-40 aryl; substituted or unsubstituted C7-15 aralkyl; substituted or unsubstituted C2-20 alkynyl; and a non-hydrocarbonaceous polar group including at least one element selected from the group consisting of oxygen, nitrogen, phosphorus, sulfur, silicon and boron, or

R₁ and R₂, or R₃ and R₄ may be bound to each other to form a C1-10 alkylidene group, or R₁ or R₂ may be bound to one of R₃ and R₄ to form C4-12 saturated or unsaturated cyclo alkyl or C6-24 aromatic compound,

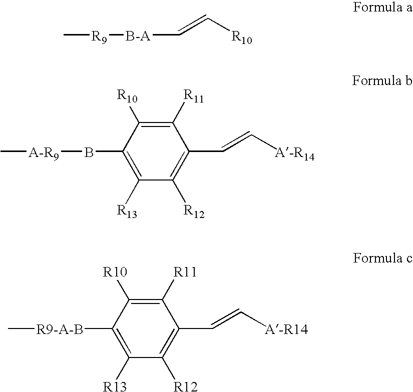

in the formulas a, b and c, A and A′ are each independently selected from the group consisting of substituted or unsubstituted C1-20 alkylene, carbonyl, carboxy, and substituted or unsubstituted C6-40 arylene;

B is oxygen, sulfur or —NH—;

R₉ is selected from the group consisting of a single bond, substituted or unsubstituted C1-20 alkylene, substituted or unsubstituted C2-20 alkenylene; substituted or unsubstituted C5-12 saturated or unsaturated cyclo alkylene; substituted or unsubstituted C6-40 arylene; substituted or unsubstituted C7-15 aralkylene; and substituted or unsubstituted C2-20 alkynylene;

R₁₀, R₁₁, R₁₂, R₁₃, and R₁₄ are each independently selected from the group consisting of substituted or unsubstituted C1-20 alkyl, substituted or unsubstituted C1-20 alkoxy, substituted or unsubstituted C6-30 aryloxy, substituted or unsubstituted C6-40 aryl, substituted or unsubstituted C6-40 alkoxyaryl, and heteroaryl having 6 to 40 carbon atoms and including 14 to 16 group heteroelements (S, O, N, etc.) in the periodic table.

According to another aspect of one embodiment of the present invention, there is provided a method for preparing a retardation film, including:

forming a copolymer layer on a substrate by coating the substrate with a polymer solution including a polymerization unit derived from the following Formula 1 and drying the polymer solution;

forming an alignment layer by irradiating the copolymer layer with linearly polarized ultraviolet rays in a predetermined direction relative to a proceeding direction of the copolymer layer to give an orientation to the copolymer layer;

forming a liquid crystal layer on the alignment layer by coating the alignment layer with a nematic liquid crystal solution and drying the nematic liquid crystal solution; and

fixing the orientation of the liquid crystal layer by curing the liquid crystal layer:

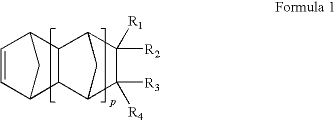

wherein, p, R1, R2, R3 and R4 are defined as in the above.

According to still another aspect of one embodiment of the present invention, there is provided a polarizer including the retardation film of one embodiment of the present invention and a polarizer film.

### ADVANTAGEOUS EFFECTS

As described above, the retardation film according to one embodiment of the present invention and the method for preparing the retardation film may be useful to improve the thermal stability and light reaction speed at the presence of the alignment layer prepared using a polymer whose main chain includes a polycyclic compound having a high glass transition temperature. Also the alignment layer constituting the retardation film according to one embodiment of the present invention may be useful to adjust an angle between a proceeding direction of the retardation film and a optical axis of liquid crystal to any of the entire angle range by irradiating the alignment layer with polarized ultraviolet rays, which makes it possible to prepare the retardation film in the form of continuous veneer boards.

### BRIEF DESCRIPTION OF THE DRAWINGS

FIG. 1 is a diagram illustrating a method for preparing a retardation film using a photo-alignment layer according to one embodiment of the present invention.

FIG. 2 is a diagram illustrating a method for preparing a retardation film in which an alignment layer is oriented in a predetermined angle according to one embodiment of the present invention.

FIG. 3 is a diagram illustrating a retardation film, in the stacked form, prepared according to the method of one embodiment of the present invention.

FIG. 4 is a graph illustrating transmittances of the retardation film as described in Experimental example 2 of one embodiment of the present invention.

FIG. 5 is a graph illustrating transmittances of the retardation film of one embodiment of the present invention, depending on the temperature of the alignment layer as described in Experimental example 3.

FIG. 6 is a graph illustrating values of measured quantitative phase differences of the retardation film prepared in Example 1 of one embodiment of the present invention.

FIG. 7 is a graph illustrating values of measured quantitative phase differences of the retardation film prepared in Example 2 of one embodiment of the present invention.

FIG. 8 is a graph illustrating values of measured quantitative phase differences of the retardation film prepared in Example 3 of one embodiment of the present invention.

### BRIEF DESCRIPTION OF MAJOR PARTS IN DRAWINGS

1: substrate film
2: alignment layer (copolymer layer)
3: UV polarizer
4: ultraviolet rays
5: liquid crystal layer (phase difference layer)
6: absorption axis of UV polarizer
7: proceeding direction of liquid crystal film
8: proceeding direction of film
9: stacked retardation film

### BEST MODE FOR CARRYING OUT THE INVENTION

Hereinafter, exemplary embodiments of the present invention will be described in more detail.

According to one embodiment of the present invention, the retardation film having excellent thermal stability and improved light reaction speed is prepared since an alignment layer is made of polymer whose main chain includes a polycyclic compound having a photoreactive group as a photoalignment material. Also, the alignment layer, which is made of the polymer whose main chain includes a polycyclic compound having photoreactive group as a photoalignment material, may adjust an angle between a proceeding direction of a film and an optical axis of liquid crystal to a predetermined angle range by irradiating the alignment layer with polarized ultraviolet rays.

Since the polymer has a main chain including the polycyclic compound having photoreactive group; the polymer has characteristics that it has excellent thermal stability since it has a high glass transition temperature. Also, since the polymer has a relatively larger vacant lattice site, the photoreactive group may move relatively freely on the polymer, and therefore it has an advantage that it is possible to improve the slow light reaction speed that has been pointed out as the disadvantage of polymer materials for preparing a liquid crystal alignment layer in the conventional liquid crystal display devices.

Additionally, the retardation film according to one embodiment of the present invention has an advantage that it possible to stack the retardation films in the form of continuous veneer boards with polarizers (polarizer films).

In the retardation film according to one embodiment of the present invention, the polymer including a polymerization repeating unit (monomer) represented by the following Formula 1 is used as a photoalignment material that is a polycyclic compound having photoreactive group used to form an alignment layer (a copolymer layer). A polymerization degree of the polymer having the polymerization repeating unit derived from the following Formula 1 is preferably in a range from 50 to 5,000. When the polymerization degree is less than 50, the polymer does not show good alignment characteristics. On the contrary when the polymerization degree exceeds 5,000, the viscosity of the polymer is increased with an increasing molecular weight, which leads to the difficulty to form an alignment layer whose thickness is controlled to a precise thickness level.

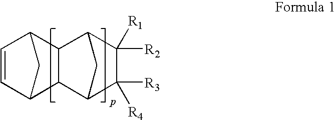

wherein, P is integer from 0 to 4,

at least one of R₁, R₂, R₃ and R₄ is a radical selected from the group consisting of the following Formulas a, b, and c, and

the rest of R₁, R₂, R₃, and R₄ are each independently selected from the group consisting of hydrogen; halogen; substituted or unsubstituted C1-20 alkyl, substituted or unsubstituted C2-20 alkenyl; substituted or unsubstituted C5-12 saturated or unsaturated cycloalkyl; substituted or unsubstituted C6-40 aryl; substituted or unsubstituted C7-15 aralkyl; substituted or unsubstituted C2-20 alkynyl; and a non-hydrocarbonaceous polar group including at least one element selected from the group consisting of oxygen, nitrogen, phosphorus, sulfur, silicon and boron, or

R₁ and R₂, or R₃ and R₄ may be bound to each other to form a C1-10 alkylidene group, or R₁ or R₂ may be bound to one of R₃ and R₄ to form C4-12 saturated or unsaturated cyclo alkyl or C6-24 aromatic compound,

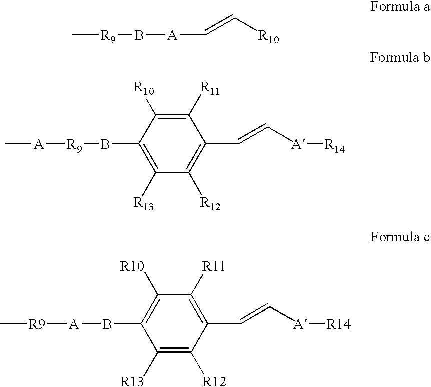

in the formulas a, b and c, A and A′ are each independently selected from the group consisting of substituted or unsubstituted C1-20 alkylene, carbonyl, carboxy, and substituted or unsubstituted C6-40 arylene;
B is oxygen, sulfur or —NH—;

R₉ is selected from the group consisting of a single bond, substituted or unsubstituted C1-20 alkylene, substituted or unsubstituted C2-20 alkenylene; substituted or unsubstituted C5-12 saturated or unsaturated cyclo alkylene; substituted or unsubstituted C6-40 arylene; substituted or unsubstituted C7-15 aralkylene; and substituted or unsubstituted (2-20 alkynylene; and

R₁₀, R₁₁, R₁₂, R₁₃, and R₁₄ are each independently selected from the group consisting of substituted or unsubstituted C1-20 alkyl, substituted or unsubstituted C1-20 alkoxy, substituted or unsubstituted C6-30 aryloxy, substituted or unsubstituted C6-40 aryl, heteroaryl having 6 to 40 carbon atoms and including 14 to 16 group heteroelements (S, O, N, etc.) in the periodic table, and substituted or unsubstituted C6-40 alkoxyaryl.

Representative examples of the C6-40 aryl and the heteroaryl having 6 to 40 carbon atoms and including 14 to 16 group heteroelements (S, O, N, etc.) in the periodic table include compounds represented by the following Formula 2, but the present invention is not particularly limited thereto:

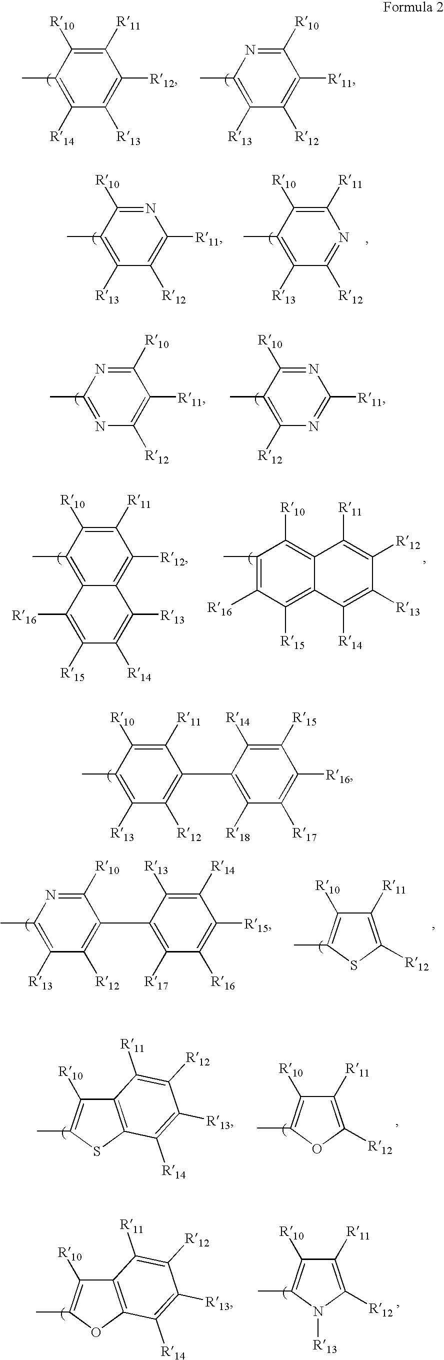

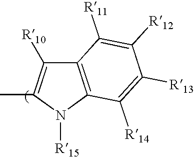

wherein, at least one of R′₁₀, R′₁₁, R′₁₂, R′₁₃, R′₁₄, R′₁₅, R′₁₆, R′₁₇ and R′₁₈ is essentially substituted or unsubstituted alkoxy having carbon atoms of 1 to 20, or substituted or unsubstituted aryloxy having carbon atoms of 6 to 30, and the rest of the R′₁₀, R′₁₁, R′₁₂, R′₁₃, R′₁₄, R′₁₅, R′₁₆, R′₁₇ and R′₁₈ are each independently substituted or unsubstituted alkyl having carbon atoms of 1 to 20, substituted or unsubstituted alkoxy having carbon atoms of 1 to 20, substituted or unsubstituted aryloxy having carbon atoms of 6 to 30, or substituted or unsubstituted aryl having carbon atoms of 6 to 40.

In the Formula 1, specific examples of the non-hydrocarbonaceous polar group include, but are not limited to, —OR₆, —OC(O)OR₆, —R₅OR₆, —R₅OC(O)OR₆, —C(O)OR₆, —R₅C(O)OR₆, —C(O)R₆, —R₅C(O)R₆, —OC(O)R₆, —R₅OC(O)R₆—(R₅O)—OR₆ (q is integer from 1 to 10), —(OR₅)_{q}—OR₆ (q is integer from 1 to 10), —C(O)—O—C(O)R₆, —R₅C(O)—O—C(O)R₆, —SR₆, —R₅SR₆, —SSR₆, —R₅SSR₆, —S(═O)R₆, —R₅S(═O)R₆, —R₅C(═S)R₆, —R₅C(═S)SR₆, —R₅ SO₃R₆, —SO₃R₆, —R₅N═C═S, —N═C═S, —NCO, —R₅—NCO, —CN, —R₅CN, —NNC(═S)R₆, —R₅NNC(═S)R₆, —NO₂, —R₅NO₂,

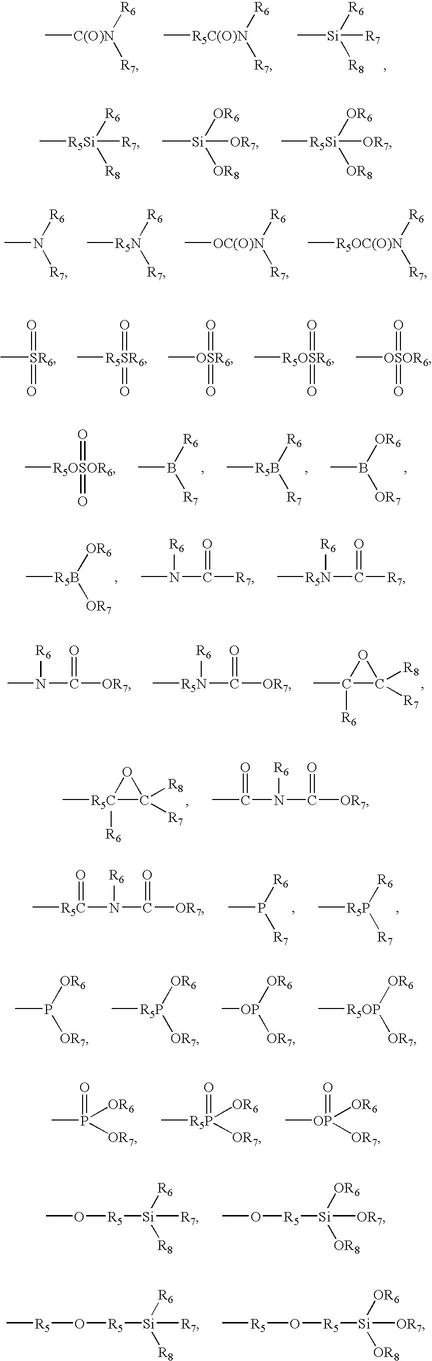

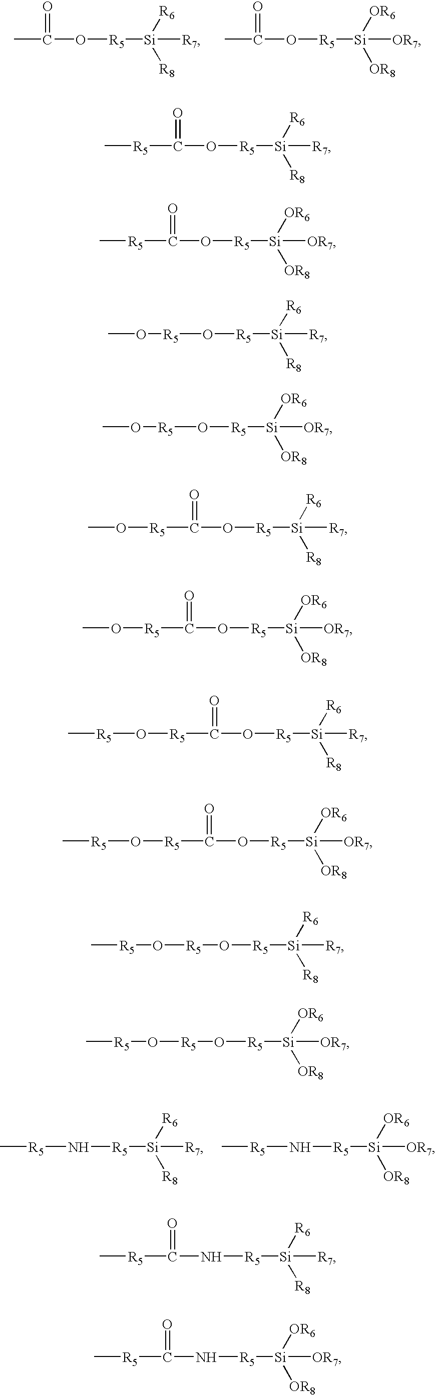

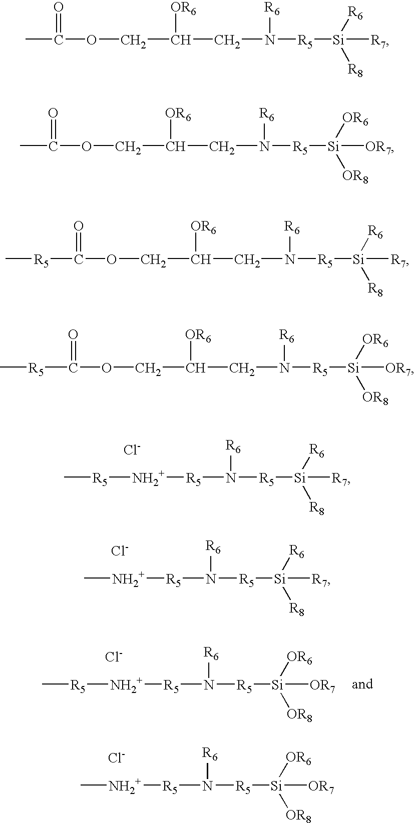

In the non-hydrocarbonaceous polar group, R₅ may be selected from the group consisting of substituted or unsubstituted C1-20 alkyl, substituted or unsubstituted C2-20 alkenyl; substituted or unsubstituted C5-12 saturated or unsaturated cycloalkyl; substituted or unsubstituted C6-40 aryl; substituted or unsubstituted C7-15 aralkyl; and substituted or unsubstituted C2-20 alkynyl, and

R₆, R₇ and R₈ are each independently may be selected from the group consisting of hydrogen; halogen; substituted or unsubstituted C1-20 alkyl, substituted or unsubstituted C2-20 alkenyl; substituted or unsubstituted C5-12 saturated or unsaturated cycloalkyl; substituted or unsubstituted C6-40 aryl; substituted or unsubstituted C7-15 aralkyl, and substituted or unsubstituted C2-20 alkynyl.

According to one embodiment of the present invention, the polymer formed of a polymerization repeating unit (a monomer) represented by the Formula 1 may include, as the polymerization repeating unit derived from the Formula 1, polymerization units of the following Formula 1a, and/or the following Formula 1b according to the ring opening reaction, and for the following Formula 1c further including a linear olefin monomer.

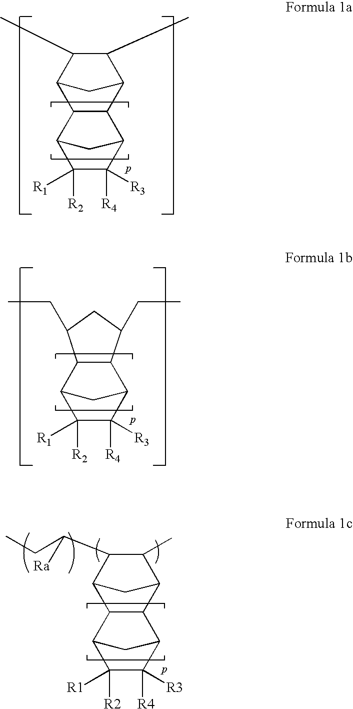

In the Formulas 1a, 1b and 1c, p, R1, R2, R3 and R4 are defined as in the Formula 1, and Ra in the Formula 1c represents hydrogen or C1-20 hydrocarbon group.

That is to say, the polymerization repeating unit of the Formula 1 may be present, but is not limited to the polymerization repeating units of the Formula 1a, Formula 1b and/or 1c in the polymer.

Specific examples of the polymer composed, of the repeating polymerization unit represented by the Formula 1a, 1b or 1c include, but are not limited thereto, the following compounds.

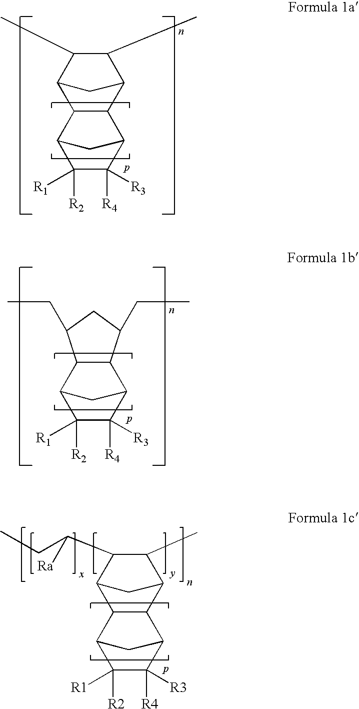

In the Formulas 1a′, 1b′ and 1c′, n represents a polymerization degree of the polymer, and ranges from 50 to 5000 due to the above-mentioned reasons. Also, In the case of the Formula 1c′, the polymer may preferably include a linear olefin repeating unit represented by ‘x’ and a cyclic monomer repeating unit represented by ‘y’ so as to achieve the easy formability owing to the low glass transition temperature, wherein a content of the linear olefin repeating unit (x) is in a range from 0.1 to 99.9 mol % and a content of the cyclic monomer repeating unit (y) is in a range from 0.1 to 99.9 mol %: The repeating order of the linear olefin and the cyclic monomer is random. When the content of the linear olefin repeating unit is less than 0.1 mol %, the solubility of the polymer may be insufficiently improved, whereas the photoreaction is not induced die to the low photoreactive group content in the polymer when the content of the linear olefin repeating unit exceeds 99.9 mol %. Also, p, R1, R2, R3, R4 and Ra are defined as in the Formulas 1 and 1c.

The polymer used to form the alignment layer of one embodiment of the present invention may further include a compound of the following Formula 3 as a repeating unit constituting the polymer, and the polymer including the compounds of the above-mentioned formulas preferably have a polymerization degree of 50 to 5,000 due to the above-mentioned reasons:

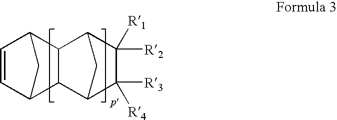

In the Formula 3, p′ is integer from 0 to 4, and

R′₁, R′₂, R′₃ and R′₄ are each independently selected from the group consisting of hydrogen; halogen; substituted or unsubstituted C1-20 alkyl, substituted or unsubstituted C2-20 alkenyl; substituted or unsubstituted C5-12 saturated or unsaturated cycloalkyl; substituted or unsubstituted C6-40 aryl; substituted or unsubstituted C7-15 aralkyl; substituted or unsubstituted C2-20 alkynyl; and a non-hydrocarbonaceous polar group including at least one element selected from the group consisting of oxygen, nitrogen, phosphorus, sulfur, silicon and boron, or

R′₁ and R′₂ or R′₃ and R′₄ may be bound to each other to form a C1-10 alkylidene group, or R′₁ or R′₂ may be bound to one of R′₃ and R′₄ to form C4-12 saturated or unsaturated cyclo alkyl or C6-24 aromatic cyclic compound.

In the Formula 3, specific examples of the non-hydrocarbonaceous polar group, include, but are not limited thereto, —OR₆, —OC(O)OR₆, —R₅OR₆, —R₅OC(O)OR₆, —C(O)OR₆, —R₅C(O)OR₆, —C(O)R₆, —R₅C(O)R₆, —OC(O)R₆, —R₅OC(O)R₆, —(R₅O)_{q}—OR₆ (q is integer from 1 to 10), —(OR₅)_{q}—OR₆ (q is integer from 1 to 10), —C(O)—O—C(O)R₆, —R₅C(O)—O—C(O)R₆, —SR₆, —R₅SR₆, —SSR₆, —R₅SSR₆, —S(═O)R₆, —R₅S(═O)R₆, —R₅C(═S)R₆, —R₅C(═S)SR₆, —R₅SO₃R₆, —SO₃R₆, —R₆, —N═C═S, —NCO, —R₅—NCO, —CN, —R₅CN, —NNC(═S)R₆, —R₅NNC(═S)R₆, —N═C═S, —NO₂, —R₅NO₂,

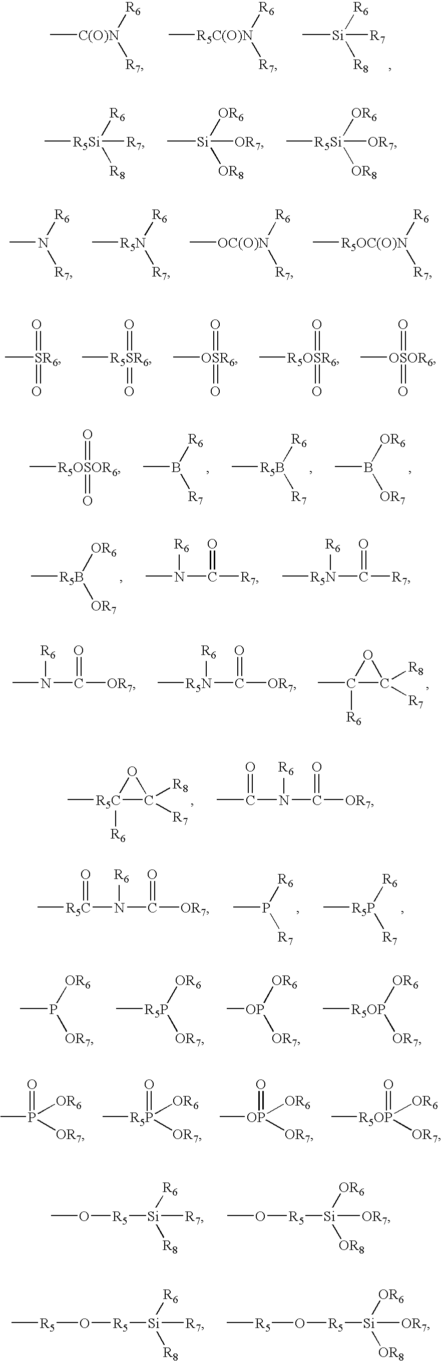

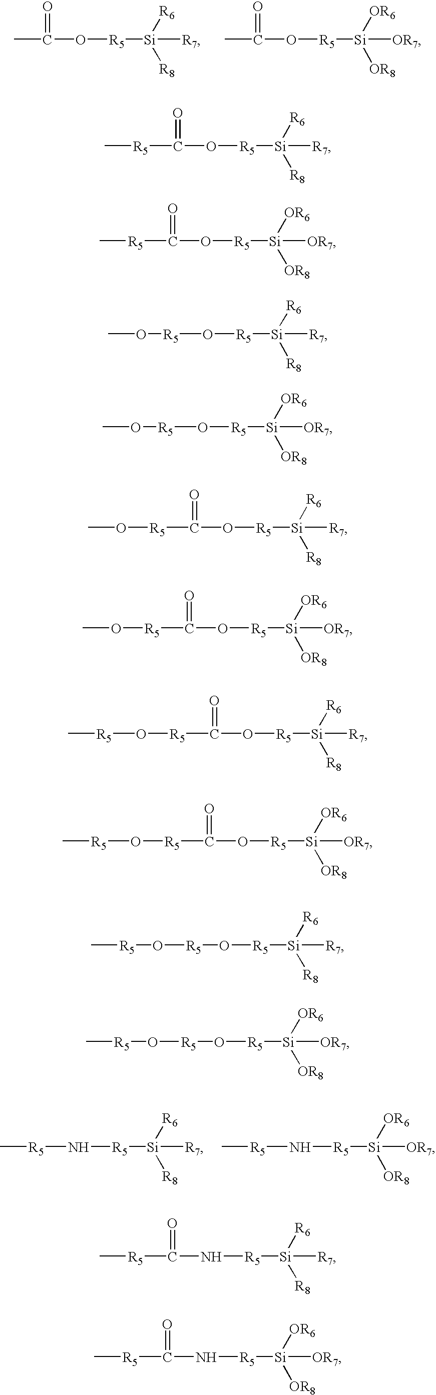

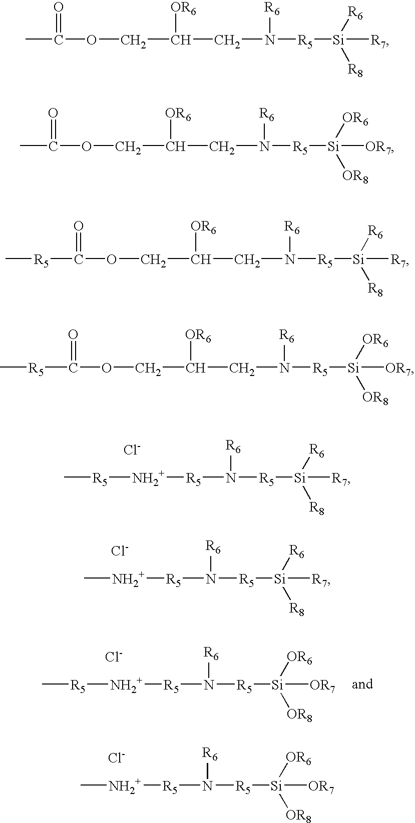

In the specific examples of the non-hydrocarbonaceous polar group, R₅ may be selected from the group consisting of hydrogen; halogen; substituted or unsubstituted C1-20 alkyl, substituted or unsubstituted C2-20 alkenyl; substituted or unsubstituted C5-12 saturated or unsaturated cyclo alkyl; substituted or unsubstituted C6-40 aryl; substituted or unsubstituted C7-15 aralkyl; and substituted or unsubstituted C2-20 alkynyl,

R₆, R₇, and R₈ are each independently may be selected from the group consisting of hydrogen; halogen; substituted or unsubstituted C1-20 alkyl, substituted or unsubstituted C2-20 alkenyl; substituted or unsubstituted C5-12 saturated or unsaturated cyclo alkyl; substituted or unsubstituted C6-40 aryl; substituted or unsubstituted C7-15 aralkyl; and substituted or unsubstituted C2-20 alkynyl.

According to one embodiment of the present invention, the polymerization repeating unit (monomer) derived from the Formula 3 may be present as one of the polymerization repeating units of the following Formula 3a, or the Formula 3b according to the ring opening reaction in the polymer including the polymerization unit derived from the Formula 1 of one embodiment of the present invention. Also, the repeating unit structure of the following Formula 3a may also be present as the polymerization unit of the Formula 3c including a linear olefin monomer. That is to: say, in the polymer including the polymerization unit derived from the Formula 1 according to one embodiment of the present invention, the polymerization repeating unit of the Formula 3 may be present as the polymerization repeating units of the following Formulas 3a, 3b and/or 3c:

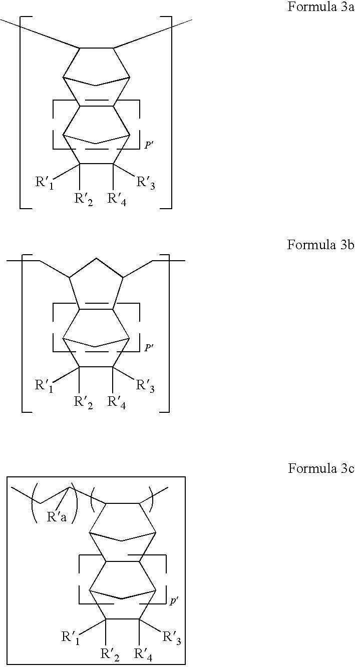

in the formulas 3a, 3b and 3c, p′, R′₁, R′₂, R′₂ and R′₄ are defined as in the Formula 3, and R′a in the Formula 3c represents hydrogen or C1-20 hydrocarbon group,

When the polymer used to form the alignment layer according to embodiment of the present invention further includes the polymerization repeating unit derived from the Formula 3, the repeating unit derived from the Formula 3 may be present at the maximum content of 99 mol %, based on 100 mol % of the polymer, and the Polymer preferably includes 1 to 99 mol % of the repeating unit derived from the Formula 3, and 1 to 99 mol % of the repeating unit derived from the Formula 1. The polymerization repeating unit derived from the Formula 3 may be added optionally, and, thus, there is no limitation on the lowest limit value of the polymerization repeating unit. However, the repeating unit derived from the Formula 3 is preferably present at a content of 1 mol % or more so as to show effects, such as improved solubility, that results from the addition of the repeating unit of the Formula 3. When the content of the repeating unit derived from the Formula 3 exceeds 99 mol %, the light reaction speed may slow down due to the relatively low content of the photoreactive functional group of the Formula 1. Also, the polymer including the polymerization repeating units derived from the Formulas 1 and 3 preferably have a polymerization degree of 50 to 5,000 due to the above-mentioned reasons:

The definition of the above-mentioned substituents will be described in detail; as follows.

The term “alkyl” means a straight or branched saturated monovalent hydrocarbon moiety having carbon atoms of C1-20, preferably C1-10, and more preferably C1-6. The alkyl group may be optionally substituted with at least one halogen. Examples of the alkyl group include, but are not particularly limited to, methyl, ethyl, propyl, 2-propyl, n-butyl, iso-butyl, tert-butyl, pentyl, hexyl, dodecyl, fluoromethyl, difluoromethyl, trifluoromethyl, chloromethyl, dichloromethyl, trichloromethyl, iodomethyl, bromomethyl, etc.

The term “alkenyl” means a straight or branched monovalent hydrocarbon moiety having carbon atoms of C2-20, preferably C2-10, and more preferably C2-6, and including at least one carbon-carbon double bond. The alkenyl group may bind to the chemical structures through the carbon atoms including the carbon-carbon double bond, or the saturated carbon atoms. The alkenyl group may be optionally substituted with at least one halogen. Examples of the alkenyl group include, but are not particularly limited to, ethenyl, 1-propenyl, 2-propenyl, 2-butenyl, 3-butenyl, pentenyl, 5-hexenyl, dodecenyl, etc.

The term “cycloalkyl” means a saturated or unsaturated non-aromatic monovalent monocyclic, bicyclic or tricyclic hydrocarbon moiety of C5-12 cyclic carbons, and the cycloalkyl group may be optionally substituted with at least one halogen. For example, the cycloalkyl group includes, but are not particularly limited to, cyclopropyl, cyclobutyl, cyclopentyl, cyclopentenyl, cyclohexyl, cyclohexenyl, cycloheptyl, cyclooctyl, decahydronaphthalenyl, adamantyl, norbornyl (i.e., bicyclo[2.2.1]hept-5-enyl), etc.

The term “aryl” means a monovalent monocyclic, bicyclic or tricyclic aromatic hydrocarbon moiety having carbon atoms of 6 to 40, preferably 6 to 20, and more preferably 6 to 12, and the aryl group may be optionally substituted with at least one halogen. The aromatic moiety of the aryl group includes only carbon atoms. Examples of the aryl group include, but are not particularly limited to, phenyl, naphthalenyl and fluorenyl.

The term “alkoxyaryl” means a moiety in which at least one hydrogen in the above-defined aryl group is substituted with alkoxy group. Examples of the alkoxyaryl group include, but are not particularly limited to, methoxyphenyl, ethoxyphenyl, propoxyphenyl, butoxyphenyl, pentoxyphenyl, hexoxyphenyl, heptoxyphenyl, octoxyphenyl, nanoxyphenyl, methoxybiphenyl, ethoxybiphenyl, propoxybiphenyl, methoxynaphthalenyl, ethoxynaphthalenyl, propoxynaphthalenyl, methoxyanthracenyl, ethoxyanthracenyl, propoxyanthracenyl, methoxyfluorenyl, etc.

The term “aralkyl” means a moiety in which at least one hydrogen in the above-defined alkyl group is substituted with aryl group, and the aralkyl group may be optionally substituted with at least one halogen. For example, the aralkyl group includes, but are not particularly limited to, benzyl, benzhydryl, trityl, etc. The aryl group is defined as in the above.

The term “alkynyl” means a straight or branched monovalent hydrocarbon moiety having carbon atoms of C2-20, preferably C2-10, and more preferably C2-6, and including at least one carbon-carbon triple bond. The alkynyl group may bind to the chemical structures through the carbon atoms including the carbon-carbon triple bond, or the saturated carbon atoms. The alkynyl group may be optionally substituted with at least one halogen. For example, the alkynyl group includes ethinyl, propinyl, etc.

The term “alkylene” means a straight or branched, saturated bivalent hydrocarbon moiety having carbon atoms of 1 to 20, preferably 1 to 10, and more preferably 1 to 6. The alkylene group may be optionally substituted with at least one halogen. Examples of the alkylene group include, but are not particularly limited to, methylene, ethylene, propylene, butylene, hexylene, etc.

The term “alkenylene” means a straight or branched bivalent hydrocarbon moiety having carbon atoms of 2 to 20, preferably 2 to 10, and more preferably 2 to 6, and including at least one carbon-carbon double bond. The alkenylene group may bind to the chemical structures through the carbon atoms including the carbon-carbon double bond, or the saturated carbon atoms. The alkenylene group may be optionally substituted with at least one halogen.

The term “cycloalkylene” means a saturated or unsaturated non-aromatic bivalent monocyclic, bicyclic or tricyclic hydrocarbon moiety of 5 to 12 cyclic carbons, and the cycloalkylene group may be optionally substituted with at least one halogen. For example, the cycloalkylene group includes cyclopropylene, cyclobutylene, etc.

The term “arylene” means a bivalent monocyclic, bicyclic or tricyclic aromatic hydrocarbon moiety having carbon atoms of 6 to 40, preferably 6 to 20, and more preferably 6 to 12, and the arylene group may be optionally substituted with at least one halogen. The aromatic moiety of the arylene group includes only carbon atoms. Examples, of the arylene group include phenylene, etc.

The term “aralkylene” means a bivalent moiety in which at least one hydrogen in the above-defined alkyl group is substituted with aryl group, and the aralkylene group may be optionally substituted with at least one halogen. For example, the aralkylene group includes benzylene, etc. The aryl group is defined as in the above.

The term “alkynylene” means a straight or branched bivalent hydrocarbon moiety having carbon atoms of 2 to 20, preferably 2 to 10, and more preferably 2 to 6, and including at least one carbon-carbon triple bond. The alkynylene group may bind to the chemical structures through the carbon atoms including the carbon-carbon triple bond, or the saturated carbon atoms. The alkynylene group may be optionally substituted with at least one halogen. For example, the alkynylene group includes ethinylene, propinylene, or the like.

The term “bond” refers to a moiety having a carbon-carbon single bond without having any added substituent.

The expression “hydrocarbon group” in the substituents Ra and R′a means the above-defined alkyl, cycloalkyl, alkylene and cyclo alkylene groups, and the hydrocarbon group includes, for example, α-olefin, butadiene, pentadiene, etc.

Groups (e.g., R₁ to R₁₄ in Formula 1, R₅ to R₈ in the non-hydrocarbonaceous polar group, R′₁₀ to R′₁₈ in the Formula 2, R′₁ to R′₄ in the Formula 3, etc.) constituting the compound according to one embodiment of the present invention, unless otherwise specifically stated herein, are used as the meaning that is generally understood by those skilled in the art. For the substitution, the groups may be substituted with other groups, for example halogen.

It is understood that the term halogen used in this application includes fluoro, chloro, bromo and iodine.

Hereinafter, the method for preparing a polymer that is used to form the alignment layer of one embodiment of the present invention will be described in more detail.

The polymer whose main chain includes a polycyclic compound having photoreactive group according to one embodiment of the present invention may be prepared, but is not particularly limited to, by polymerizing a monomer solution of the compound represented by the Formula 1 at the presence of a later-described catalyst mixture. However, the order of added catalyst, monomer and solvent, the kinds and content of the solvents, and the like may be widely varied according to the necessity of those skilled in the art, but the present invention is not particularly limited thereto.

The polycyclic compound having photoreactive group, for example, the polymer having a main chain including a repeating unit of the Formula 1a may be prepared at a temperature of 10 to 200° C. (celsius) at the presence of a catalyst mixture of a precatalyst including 10-group transition metals and a first cocatalyst providing Lewis base that may weakly coordinately bind to metals in precatalyst. A second cocatalyst providing a Lewis base may also be further used in the polymerization reaction.

When the reaction temperature is less than 10° C. (celsius), the catalyst has a low polymerization activity, whereas the catalyst may be degraded when the reaction temperature exceeds 200° C. (celsius).

The catalyst mixture preferably includes 1 to 1000 moles of the first cocatalyst providing a Lewis base that may weakly coordinately bind to metals in precatalyst, based on 1 mole of the precatalyst including 10-group transition metals. When the content of the first cocatalyst is less than 1 mole, the catalyst is not activated, but, on the contrary, the catalyst activity of the precatalyst may be low when the content of the first cocatalyst exceeds 1000 moles.

Also, the second cocatalyst, as an optional component, is preferably used at a content of at most 1000 moles, and preferably from 1 to 1000 moles, based on 1 mole of the precatalyst. The activation effect of the precatalyst on the addition of the second cocatalyst is slight when the content of the second cocatalyst is less than 1 mole, whereas both of the polymerization yield and molecular weight of the polymer are rather low when the content of the second cocatalyst exceeds 1000 moles.

In addition, a ring-opened norbornene polymer according to one embodiment of the present invention, for example a polymer having a main chain including the repeating unit of the Formula 1b, may be prepared at a temperature of 10 to 200° C. (celsius) as described above, for example by using the following polymerization catalysts. A mixture of at least one compound selected from the group consisting of W, Mo, Re, V. and Ti compounds (component (a)) and at least one compound selected from the group consisting of Li, Na, K, Mg, Ca, Zn, Cd, Hg, B, Al, Si, Sn and Pb compounds (component (b)) are used as the polymerization catalysts. Representative examples of the component (a) include WCl₆, MoCl₅, ReOCl₃, VOCl₃, TiCl₄, etc. and representative examples of the compounds used as the component (b) include BuLi, Et₃Al, Et₂AlCl, Et_{1.5}AlCl_{1.5}, EtAlCl₂, methyl aluminoxane, LiH, etc. Here, the components (a) and (b) may be used within the molar ratio of 0.005:1 to 15:1 in consideration of the reactivities of the catalysts.

Meanwhile, a copolymer of ethylene and cycloolefin according to one embodiment of the present invention, for example a copolymer including the repeating unit of the Formula 1c, may be prepared at a temperature of 10 to 200° C. (celsius) as described above, for example by using a vanadium-type Ziegler-Natta catalyst and/or metallocene catalyst (component (a)), a methyl aluminoxane and/or ansa-metallocene catalyst (component (b)), etc. Here, the components (a) and (b) may be used within the molar ratio of 0.00001:1 to 0.001:1 in consideration of the activities of the catalysts. The catalysts are not activated when the molar ratio of the component (a) is less than 0.00001:1, whereas the catalyst activity is low when the molar ratio of the component (a) exceeds 0.001:1.

Hereinafter, the method for preparing a retardation film according to one embodiment of the present invention will be described in more detail with reference to the accompanying drawings.

The retardation film according to one embodiment of the present invention may be prepared by forming a copolymer layer on a substrate by coating the substrate with a solution of polymer (hereinafter, referred to as a ‘polymer solution’) having a main chain including polycyclic compounds having photoreactive group of the Formula 1 and drying the solution of polymer, followed by forming an alignment layer (i.e., an oriented copolymer layer) by irradiating the copolymer layer with ultraviolet rays to give orientation to the copolymer layer, coating the alignment layer with a nematic liquid crystal solution and drying and curing the nematic liquid crystal solution.

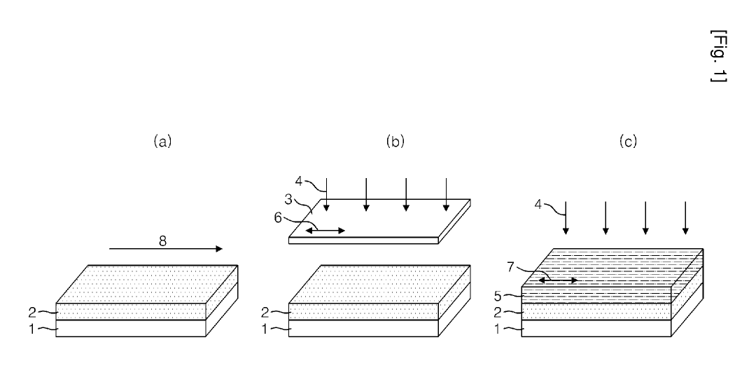

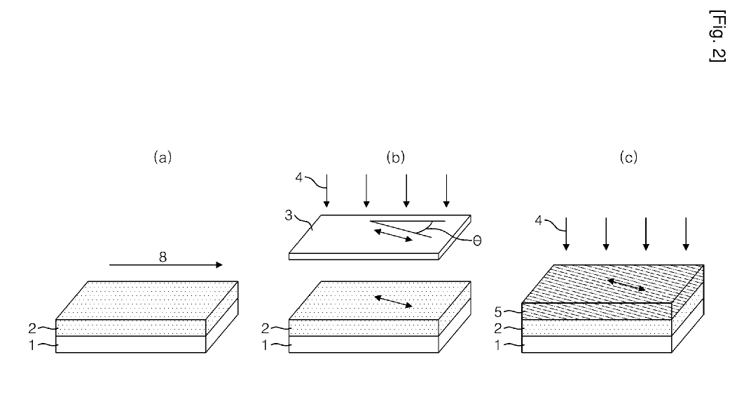

FIG. 1 is a diagram illustrating a method for preparing a retardation film using a photoalignment layer according to a method of one embodiment of the present invention. As shown in FIG. 1(a) and FIG. 2(a), a copolymer layer 2 is formed by coating a substrate film 1 with a polymer solution having a main chain including a polycyclic compound according to one embodiment of the present invention and drying the polymer solution. Then, an alignment layer 2 is formed by irradiating the copolymer layer 2 with ultraviolet rays 4 to give orientation to the copolymer layer 2, as shown in FIG. 1(b) and FIG. 2(b). Where the copolymer layer 2 is irradiated with ultraviolet rays to give orientation to the copolymer layer 2, the alignment layer 2 may be endowed with orientation in a direction in which the alignment layer 2 is oriented at any of desired angles relative to a proceeding direction of the substrate by optionally adjusting a polarization direction of the ultraviolet rays relative to the alignment layer 2. That is to say, the alignment layer 2 may be endowed with orientation in a certain direction spanning from a horizontal direction to a vertical direction relative to the proceeding direction of the substrate by irradiating the alignment layer with ultraviolet rays 4 according to the method of one embodiment of the present invention.

In order to form the alignment layer, the above-mentioned polymer solution is first prepared. An organic solvent is used as the solvent in the preparation of the polymer solution, and examples of the organic solvent include, but are not particularly limited to, at least one solvent selected from the group consisting of c-pentanone, chlorobenzene, N-methylpyrrolidone, dimethylsulfoxide, dimethylformamide; toluene, chloroform, gamma-butyrolactone and tetrahydrofuran.

The content of the polymer in the polymer solution is selected in consideration of the viscosity and the volatility of the polymer solution, etc. In this case, the content of the polymer is in a range from 0.1 to 20% by weight (percent by weight), and more preferably from 1 to 10% by weight (percent by weight), based on the total weight of the polymer solution. When the content of the polymer is less than 0.1. % by weight (percent by weight), it is impossible to obtain a good alignment layer due to the thin thickness of the thin film. On the contrary, when the content of the polymer exceeds 20% by weight (percent by weight), it is difficult to obtain a good alignment layer due to the increased thickness of the thin film, and the coating properties of the polymer solution are deteriorated due to the increased viscosity of the polymer solution.

As the substrate 1, substrates that is optically transparent and maintains its flatness, and generally used in the retardation film may be used. Examples of the substrate 1 include, but are not particularly limited to, cyclo olefin polymers (for example, triacetyl cellulose, polyethylene terephthalate, polymethylmethacrylate, polycarbonate, polyethylene and norbornene derivatives), polyvinyl alcohol, diacetyl cellulose, polyether sulfone film or glass substrate, etc.

The substrate 1 is coated with a polymer solution. There is no limitation on coating methods, but any of coating methods of coating a substrate to a uniform thickness widely known in the art may be used herein. These coating methods include spin coating, wire-bar coating, micro gravure coating, gravure coating, dip coating, spray coating methods, etc.

The thickness of the polymer solution coated onto the substrate 1 may be varied according to the coating conditions. However, when the polymer solution is dried, the thickness of the alignment layer is preferably in a range from approximately 800 to 2000 (Angstrom). When the thickness of the alignment layer is less than 800 (Angstrom), the alignment layer has an insufficient orientation, whereas the coating uniformity is low when the thickness of the alignment layer exceeds 2000 Å (Angstrom).

After the substrate 1 is coated with the polymer solution, the polymer solution may be dried at 70 to 300° C. (celsius) for 30 seconds to 60 minutes to remove solvent residuals. The solvents may also be removed, when necessary, by heating the polymer solution at a higher temperature for an extended time of 1 hour or more. When the drying temperature is less than 70° C. (celsius), the polymer solution is not sufficiently dried, and therefore the alignment layer may be stained or the orientation of the alignment layer may be poor die to the presence, of the residual solvents. On the contrary, the substrate film may be shriveled or damaged due to the high drying temperature when the drying temperature exceeds 300° C. (celsius).

When the drying time is less than 30 seconds, the polymer solution is not sufficiently dried, and therefore the orientation of the alignment layer may be poor die to the presence of the residual solvents. On the contrary, the operation efficiencies may be poor the to the extended drying time when the drying time exceeds 60 minutes.

The solvent-free polymer coating layer 2 may be oriented in a desired direction by irradiating the polymer coating layer 2 with linearly polarized ultraviolet rays 4 in a desired predetermined direction. That is to say, the polymer forming the alignment layer according to one embodiment of the present invention is oriented in a vertical direction (absorption axis) to the transmission axis of a UV polarizer due to the cyclo addition reaction through the irradiation of the ultraviolet rays (FIG. 1(b)). Also, an orientation direction of the alignment layer may be adjusted to a desired angle (θ) by adjusting the polarization of the irradiated ultraviolet rays (for example, by rotating the UV polarizer), as shown in FIG. 2(b).

In particular, the irradiation of ultraviolet rays may be carried out by irradiating a surface of the polymer coating layer 2 with polarized ultraviolet rays for approximately 0.5 seconds to 60 minutes, the polarized ultraviolet rays being linearly polarized using a UV lamp and a UV polarizer (wire grid polarizer) 3, as shown in FIG. 1(b). Photoreactive group in the polymer is dimerized through the UV irradiation to primarily orient molecules of the polymer. In the case of optically oriented materials, an orientation direction where the optically oriented materials are dimerized may be determined according to the direction of linear polarization, and therefore the orientation direction of the alignment layer may be adjusted to a desired angle according to the polarization direction of the UV polarizer, the angle spanning from a horizontal direction to a vertical direction relative to the proceeding direction of a film. That is to say, the optical axis of liquid crystal may be adjusted to a desired angle relative to the proceeding direction of a film by adjusting the polarization direction of the irradiated ultraviolet rays.

There is no limitation on UV light energies. However, an orientation of the alignment layer is formed in a desired direction when the used ultraviolet ray light is irradiated with a sufficient energy, but the alignment layer has an insufficient orientation when the alignment layer is exposed to the ultraviolet ray light with an insufficient energy, which leads to the scattered array of liquid crystal molecules in coating the alignment layer with the liquid crystal solution. Therefore, the intensity of the ultraviolet ray light is suitable at 100 mW/cm² (mW/square centimeters) or more, preferably in the range of 100 to 1000 mW/cm² (mW/square centimeters), and more preferably 400 to 700 mW/cm² (mW/square centimeters). When the intensity of the ultraviolet ray light is less than 100 mW/cm² (mW/square centimeters), the liquid crystals are ununiformly distributed on the alignment layer due to the insufficient orientation, whereas a substrate film to be coated may be damaged die to the strong UV energy when the intensity of the ultraviolet ray light exceeds 1000 mW/cm² (mW/square centimeters).

Then, an alignment layer-fixing layer (a liquid crystal layer) 5 is formed by coating the alignment layer 2, which is oriented at a desired angle through the irradiation of the polarized ultraviolet rays, with a liquid crystal solution and drying the liquid crystal solution, as shown in FIG. 1(c). In this case, the alignment layer-fixing layer 5 is oriented in the same direction as the alignment of the alignment layer 2 (FIG. 1(c) and FIG. 2(c)).

Nematic liquid crystals may be used as the liquid crystal material. The nematic liquid crystals are referred to as polymerizable reactive liquid crystal monomers, and polymerized with adjacent liquid crystal monomers to form a liquid crystal polymer when the light is exposed to the liquid crystal monomers. The polymerizable liquid, crystal materials have characteristics that the liquid crystal materials are oriented in a certain direction since their phases are transitioned into a liquid crystal phase through the polymerization reaction when the liquid crystal materials are coated on the alignment layer in an isotropic state, and subject to the drying process, etc. Therefore, the alignment layer-fixing layer is desirable since the orientation of the alignment layer is not changed although other layers are staked onto the alignment layer.

Among the polymerizable liquid crystal materials, the use of at least one liquid crystal material having an acrylate group and polymerizable by the optical reaction is particularly preferably used but the present invention is not particularly limited thereto. The liquid crystal materials having an acrylate group include low molecular weight liquid crystals, such as cyano biphenyl, cyano phenyl cyclohexane, cyano phenyl ester, benzoic acid phenyl ester, phenyl pyrimidine acrylates and mixtures thereof, which show a nematic phase at a room temperature or a hot temperature.

The nematic liquid crystal used in one embodiment of the present invention preferably has a birefringence of 0.01 to 0.3. The birefringence is one of the important optical properties of the liquid crystal since the liquid crystal changes a polarization state or a polarization direction of incident light, or rotates a proceeding direction of the incident light through the anisotropy of birefringence. When the birefringence of the liquid crystal is less than 0.01, a film may be very thick to obtain a desirable phase difference value. On the contrary, when the birefringence of the liquid crystal exceeds 0.3, it is difficult to adjust the thickness of the film, and the phase difference value may be increased even though the film is thin, and therefore it is difficult to obtain a film having a constant phase difference value. Representative examples of the reactive liquid crystal material include reactive mesogen (RM, Merk), LC242 (BASF), etc.

When one of the liquid crystal materials is dissolved in a solvent, the content of the liquid crystal monomer in the liquid crystal solution may be varied according to the thickness of the liquid crystal layer and the coating methods. Here, the content of the liquid crystal monomer is preferably in a range from 5 to 70 parts by weight, and preferably from 10 to 50 parts by weight, based on 100 parts by weight of the liquid crystal solution, but the present invention is not particularly limited thereto. When the content of the liquid crystal material in the liquid crystal solution is less than 5 parts by weight, the drying time is increased due to the relatively higher content of the solvent, or stains may appear in a film surface due to the severe floating of the liquid crystal layer after the coating process. On the contrary, when the content of the liquid crystal material in the liquid crystal solution exceeds 70 parts by weight, the liquid crystal may be extracted during its storage since the content of the solvent is relatively lower than the content of the liquid crystal material, or the wetting property of the alignment layer may be deteriorated due to the extremely high viscosity.

Also, the liquid crystal solution may include a predetermined amount of a photoinitiator. The photoinitiator may be present at a content of 3 to 10 parts by weight, based on 100 parts by weight of the total solids (i.e., the liquid crystal materials and the photoinitiator except for the solvents). When the content of the photoinitiator is less than 3 parts by weight, the liquid crystal is not sufficiently cured by UV light. Whereas, when the content of the photoinitiator exceeds 10 parts by weight, the presence of the excessive photoinitiator may restrict the orientation of the liquid crystal layer and thus, the orientation does not exist in the film regardless of the orientation direction of the alignment layer. Photoinitiators that have been generally used in the art may be used herein, and there is no limitation on the kinds of the photoinitiators.

The solvents used to prepare a liquid crystal solution include, but are not particularly limited to, halogenated hydrocarbons such as chloroform, tetrachloroethane, trichloroethylene, tetrachloroethylene, chlorobenzene, etc.; aromatic hydrocarbons such as benzene, toluene, xylene, methoxy benzene, 1,2-dimethoxybenzene, etc.; ketones such as acetone, methylethylketone, cyclohexanone, cyclopentanone, etc.; alcohols such as isopropyl alcohol, n-butanol, etc.; cellosolves such as methyl cellosolve, ethyl cellosolve, butyl cellosolve, etc.; and the like. The solvents may be used alone or in combinations thereof.

Then, the coated liquid crystal solution is subject to drying and UV-curing processes to form a liquid crystal layer whose molecules are, oriented in a certain direction. For the retardation film according to one embodiment of the present invention, the liquid crystal layer shows a phase difference, and also functions to fix the orientation of the alignment layer. The nematic liquid crystal may be oriented in the same direction as the alignment layer.

The drying process is preferably carried out in a drying oven. In this case, the drying temperature is preferably in a range from 25 to 70° C. (celsius), and the drying time is preferably in a range from approximately 1 to 5 minutes. The drying temperature is one of the important factors that determine an orientation position of the liquid crystal, and the liquid crystal layer is not oriented in proper order out of the ranges of the desirable drying temperature and time. Also, since the stains may appear when the liquid crystal solution is not dried sufficiently, the drying process is preferably carried out for 1 minute or more. In particular, the liquid crystal solution is sufficiently dried when the drying process is carried out for 5 minutes. When the drying temperature is less than 25° C. (celsius), the stains may appear due to the insufficient dryness of the liquid crystal solution. However, the liquid crystal solution is sufficiently dried at a temperature greater than 70° C. (celsius). Therefore, the liquid crystal solution may be dried at a temperature range from 25 to 70° C. (celsius).

The solvents are evaporated from the liquid crystal solution by drying the liquid crystal solution, and an orientation of the oriented liquid crystal layer is fixed by curing the oriented liquid crystal layer. The curing process may be mainly divided into UV curing and thermal curing. The reactive liquid crystal monomer used in one embodiment of the present invention is a photoreactive liquid crystal monomer that is fixed through the UV irradiation, and therefore the liquid crystal layer 5 is cured by irradiating the liquid crystal layer 5 with ultraviolet rays 4, as shown in FIG. 1(c) and FIG. 2(c).

The polymerizable curing is carried out at the presence of the photoinitiator that absorbs UV wavelengths. The UV irradiation may be carried out in the air, or under a nitrogen atmosphere so as to cut off oxygen to enhance the reaction efficiency.

A medium-pressure or high-pressure mercury UV lamp or metal halide lamp having an illuminance of approximately 100 mW/cm² (mW/square centimeters) or more may be generally used as a UV curing equipment. A cold mirror or other cooling machines may be mounted between the substrate and the UV lamp so that a surface temperature of the liquid crystal layer can be maintained within the temperature range where the liquid crystal layer has liquid crystalline properties in irradiating the liquid crystal layer with UV light.

As described above, a retardation film having an alignment layer-fixing layer (a liquid crystal layer) formed therein is prepared, the alignment layer-fixing layer being oriented in the same direction as the alignment layer. The retardation film according to one embodiment of the present invention has phase difference of ¼λ (wavelength) or ½ wavelength.

The phase difference formed in the retardation film is determined according to the quality and thickness of the retardation film, and therefore it is necessary to adjust the thickness of each film layer to a suitable thickness range for the use as the ¼ wavelength retardation film and the ½ wavelength retardation film. That is to say, for the retardation film, the phase difference value is determined according to the difference in birefringence of the liquid crystal mixture and the thickness of the liquid crystal layer, and the birefringence is varied according to the kinds of the used liquid crystal materials. Therefore, the thickness of the liquid crystal layer is varied in the preparation of the retardation film, depending on the kinds of the used liquid crystals. Accordingly, the thickness of the liquid crystal layer may be adjusted to a suitable thickness range so that the liquid crystal layer can have a desired phase difference value in consideration of the birefringence of the used liquid crystals, as apparent to those skilled in the art.

For example, when an optically polymerizable acrylate liquid crystal mixture is used to form a liquid crystal layer in one embodiment of the present invention, the thickness of the liquid crystal layer is varied according to the kinds of acrylates. For example, the thickness of the ½ wavelength retardation film is desirably adjusted to a thickness range of 1.6 to 2.3 μm (micrometers), and the thickness of the ¼ wavelength retardation film is desirably adjusted to a thickness range of 0.8 to 1.5 μm (micrometers), but the present invention is not particularly limited thereto.

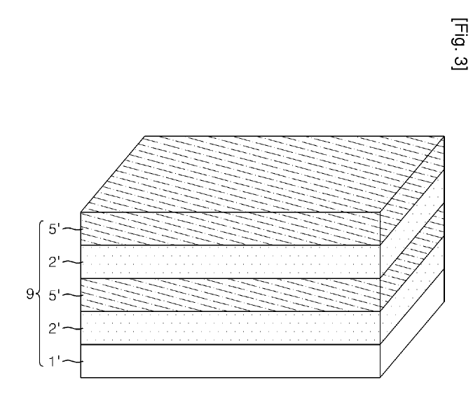

The retardation film according to one embodiment of the present invention may be prepared in the stacked form by alternately forming alignment layers 2 and 2′ and liquid crystal layers 5 and 5′ on the substrate 1, as shown in FIG. 3. The number of the stacked alignment layers and liquid crystal layers and the orientation angle of each alignment layer may be adjusted according to the methods known in the art so as to obtain a desired phase difference. When a plurality of alignment layers and liquid crystal layers are alternately stacked with each other, each of the stacked alignment layers may have the same or different orientation angles. The term ‘alternately’ means that at least two of alignment layers and at least two of liquid crystal layers are stacked over and over.

In addition, a polarizer prepared by stacking the retardation film according to one embodiment of the present invention with polarizer films is provided in another exemplary embodiment of the present invention. The polarizer according to one embodiment of the present invention may be realized to show the circular polarization, the elliptical polarization or the linear polarization.

A polarizer may be prepared by continuously stacking the retardation film, in a roll state, of one embodiment of the present invention with polarizer films without particular cutting of the retardation film.

### Mode for the Invention

Hereinafter, exemplary embodiments of the present invention will be described in more detail. However, it is understood that the description proposed herein is just a preferable example for the purpose of illustrations only, not intended to limit the scope of the invention.

All of the operations of handling compounds that are sensitive to the air and water were carried out using a standard Schlenk technique or a drive box technique in the following Examples. A nuclear magnetic resonance (NMR) spectrum was obtained using the Broker 300 spectrometer. In this case, ¹H NMR was measured at 300 MHz, and ¹³C NMR was measured at 75 MHz. The molecular weight and molecular weight distribution of the polymer were measured using the gel permeation chromatography (GPC). In this case, a polystyrene sample was used as a standard solution. Toluene was distilled in potassium/benzophenone, and dichloromethane was distilled in CaH₂.

### SYNTHETIC EXAMPLES

### Synthetic Example 1

### 1-1. Synthesis of Monomer

### Synthesis of 5-norbornene-2-methanol

Dicyclopentadiene (DCPD, Aldrich, 397 g (grams), 3 mol) and allylalcohol (Aldrich, 331 g (grams), 5.7 mol) were put into a 2 L (liters) high-pressure reactor, and heated to a temperature of 210° C. (celsius). The resulting mixture was reacted while stirring at 300 rpm, and the reaction was stopped after 1 hour. When the reaction was completed, the reaction product was cooled and transferred to a distilling apparatus. After a pressure in the distilling apparatus is reduced to 1 torr using a vacuum pump, the reaction product was distilled twice at 56° C. (celsius) under the reduced pressure to obtain a final product (yield: 52%).

¹H-NMR (300 MHz, CDCl₃): δ6.17˜5.91 (m, 2H), 3.71˜3.19 (m, 2H), 2.91˜2.75 (m, 2H), 2.38 (m, 1H), 1.83 (m, 1H), 1.60˜1.12 (m, 2H), 0.52 (m, 1H)

### Synthesis of 5-norbornene-2-methyl-(4-methoxy cinnamate)

The synthesized 5-norbornene-2-methanol (15 g (grams), 0.121 mol), 4-methoxy cinnamic acid (Aldrich, 21.5 g (grams), 0.121 mol), EDC [1-(3-dimethylaminopropyl)-3-ethylcarbodimide hydrochloride] (Aldrich, 37 g (grams), 0.194 mol) and HOBT (1-hydroxybenzotriazole hydrate) (Aldrich, 24.5 g (grams), 0.182 mol) were put into a 250 ml (milliliter) 2-neck flask and dissolved in 100 ml (milliliters) of DMF at a room temperature. The resulting reaction mixture was cooled to 0° C. (celsius), and triethylamine (Aldrich, 75 ml (milliliters), 0.605 mol) was then ailed dropwise to the reaction mixture. The reaction mixture was warmed to a room temperature, and kept for 3 hours. When the reaction was completed after the 3 hour reaction, the reaction mixture was extracted with a large amount of ethyl acetate. The resulting reaction mixture was washed with an aqueous NaHCO₃ solution, dried over anhydrous MgSO₄, and the used solvents were removed from the reaction mixture using a rotary evaporator to obtain a yellow oily product. The yellow oily product was purified using the column chromatography (hexane:ethylacetate=10:1) to obtain a pure product 5-norbornene-2-methyl-(4-methoxy cinnamate) (yield: 80%).

¹H-NMR (300 MHz, CDCl3): δ7.72˜7.66 (dd, 1H), 7.54˜7.52 (d, 2H), 6.96˜6.94 (d, 2H), 6.40˜6.34 (dd, 1H), 6.23˜6.02 (m, 2H), 4.34˜3.8 (m, 2H), 3.88 (s, 3H), 2.58˜2.47 (m, 1H), 1.95˜1.92 (m, 2H), 1.83 (m, 1H), 1.53˜1.28 (m, 2H), 0.66 (m, 1H)

### 1-2. Synthesis of Polymer

### Polymerization of 5-norbornene-2-methyl-(4-methoxy cinnamate)

20 g (grams) (70.4 mmol) of a monomer 5-norbornene-2-methyl-(4-methoxy cinnamate) and 100 ml (milliliters) of a purified toluene solvent were put into a 250 ml (milliliters) schlenk flask. 3.16 mg (milligrams) of Pd(OAc)₂ and 27 mg (milligrams) of tricyclohexylphosphonium tetrakis(pentafluorophenyl)borate dissolved in 2 ml (milliliters) of dichloromethane was aided as a catalyst into the flask, and the resulting mixture was reacted at 90° C. (celsius) for 18 hours while stirring.

After the 18 hour reaction time, the reaction mixture was added to excessive ethanol to obtain a white polymer precipitate. The precipitate was percolated through a glass funnel to recover the polymer precipitate. The recovered polymer precipitate was dried at 65° C. (celsius) for 24 hours in a vacuum oven to obtain 18 g (grams) of a polymer 5-norbornene-2-methyl-(4-methoxy cinnamate) (Mw=177,500, PDI=2.06, yield=90%).

### Synthetic Example 2

### 2-1. Synthesis of Monomer

### 4-ethoxy cinnamic acid

Pyridine (50 g (grams), excessive solvent)) and a small amount of piperidine were ailed to malonic acid (35 g (grams), 0.336 mol) at a room temperature, and the malonic acid was dissolved thoroughly for 15 minutes while stirring. Then, ethoxy benzaldehyde (25.2 g (grams), 0.168 mol) was added to the mixture, and the resulting mixture was heated to a temperature of 80° C. (celsius). The mixture was reacted overnight while CO₂ gas is violently generated as a reaction by-product, and the reaction was completed. The reaction mixture was quenched in an aqueous diluted HCl solution, and worked up with ethyl acetate. The used solvents were removed from the reaction mixture to obtain a white solid product.

### Synthesis of 5-norbornene-2-methyl-(4-ethoxy cinnamate)

4-ethoxy cinnamic acid (40 g (grams), 0.21 mol) synthesized in Example 2-1, norbornene methanol (23.5 g (grams), 0.19 mol) and 4-dimethylaminopyridine (DMAP, Aldrich, 2.56 g (grams), 0.021 mol) were added to an 1 L (liter) 2-neck flask, and dissolved in 500 ml (milliliters) of methylenechloride (MC) at a room temperature, and the resulting reaction mixture was cooled to a reaction temperature of 0° C. (celsius). Then, N,N′-dicyclohexylcarbodiimide (DCC Aldrich, 43.3 g (grams), 0.21 mol) was dissolved in 100 ml (milliliters) of MC at a room temperature, and then added dropwise to the reaction mixture. After the 30 minute reaction time, the resulting reaction mixture was warmed to a room temperature, and reacted overnight. When the reaction was completed after the overnight, the resulting by-product, urea, was filtered off and a filtrate was extracted with a large amount of ethyl acetate, washed with NaHCO₃ and H₂O, dried over anhydrous MgSO₄, and then filtered to remove the used solvents using a rotary evaporator, thus to obtain a reaction product. The reaction product was subject at −5° C. (celsius) to a recrystallization method using an acetonitrile solvent to obtain 45 g (grams) of a pure product (yield: 80%).

### 2-2. Synthesis of Polymer

### Polymerization of 5-norbornene-2-methyl-(4-ethoxy cinnamate)

13.7 g (grams) (46 mmol) of 5-norbornene-2-methyl-(4-ethoxy cinnamate) and 40 ml (milliliters) of a purified toluene solvent were added to a 250 ml (milliliter) schlenk flask. 3.4 mg (milligrams) of Pd(OAc)₂ and 29.4 mg (milligrams) of tricyclohexylphosphonium tetrakis(pentafluorophenyl)borate that were previously dissolved in 2 ml (milliliters) of dichloromethane as a catalyst were added to the flask, and reacted at 90° C. (celsius) for 18 hours while stirring.

After the 18 hour reaction time, the reaction mixture was added to excessive ethanol to obtain a white polymer precipitate. The precipitate was percolated through a glass funnel to recover the polymer precipitate. The recovered polymer precipitate was dried at 65° C. (celsius) for 24 hours in a vacuum oven to obtain 10 g (grams) of a polymer 5-norbornene-2-methyl-(4-ethoxy cinnamate) (Mw=100,000, PDI=2.48, yield=73%).

### Synthetic Example 3

### 3-1. Synthesis of Monomer

### 4-propoxy cinnamic acid

Pyridine (76.6 g (grams), 0.968 mol), piperidine (4 g (grams), 0.048 mol) and malonic acid (101 g (grams), 0.968 mol) was mixed and dissolved thoroughly at a room temperature for 15 minutes while stirring. Then, propoxy benzaldehyde (79.5 g (grams), 0.484 mol) was added to the mixture; and the resulting mixture was heated to a temperature of 80° C. (celsius). The mixture was reacted overnight while CO₂ gas is violently generated as a reaction by-product, and the reaction was completed. The reaction mixture was quenched in an aqueous diluted HCl solution to obtain a white solid product. The white solid product was then filtered, washed with water, and dried to obtain a pure white solid product.

### Synthesis of 5-norbornene-2-methyl-(4-propoxy cinnamate)

4-propoxy cinnamic acid (28 g (grams), 0.137 mol) synthesize in Example 3-1, norbornene methanol (15.5 g (grams), 0.12 mol) and DMAP (Aldrich, 1.7 g (grams), 0.014 mol) were added to a 1 L (liter) 2-neck flask, and dissolved in 300 ml (milliliters) of MC at a room temperature, and the resulting mixture was then cooled to a reaction temperature of 0° C. (celsius). Then, DCC (Aldrich, 28.3 g (grams), 0.137 mol) was dissolved 50 ml (milliliters) of MC at a room temperature, and then added dropwise to the reaction mixture. After the 30 minute reaction time, the resulting reaction mixture was slowly warmed to a room temperature, and reacted overnight. When the reaction was completed after the overnight, the resulting by-product, urea, was filtered off and a filtrate was extracted with a large amount of ethyl acetate, washed with NaHCO₃ and H₂O, dried over anhydrous MgSO₄, and then filtered to remove the used solvents using a rotary evaporator, thus to obtain a reaction predict. The reaction product was purified using a column chromatography (hexane:ethylacetate=20:1) to obtain 31 g (grams) of a pure product 5-norbornene-2-methyl-(4-propoxy cinnamate) (yield: 80%).

### 3-2. Synthesis of Polymer

### Polymerization of 5-norbornene-2-methyl-(4-propoxy cinnamate)

30.5 g (grams) (0.098 mmol) of 5-norbornene-2-methyl-(4-propoxy cinnamate) and 120 ml (milliliters) of a purified toluene solvent were added to a 250 ml (milliliter) schlenk flask. 7.3 mg (milligrams) of Pd(OAc)₂, and 62.5 mg (milligrams) of tricyclo hexylphosphonium tetrakis(pentafluorophenylpborate that were previously dissolved in 2 ml (milliliters) of dichloromethane as a catalyst were added to the flask, and reacted at 90° C. (celsius) for 18 hours while stirring.

After the 18 hour reaction time, the reaction mixture was added to excessive ethanol to obtain a white polymer precipitate. The precipitate was percolated through a glass funnel to recover the polymer precipitate. The recovered polymer precipitate was dried at 65° C. (celsius) for 24 hours in a vacuum oven to obtain 26.1 g (grams) of a polymer 5-norbornene-2-methyl-(4-propoxy cinnamate) (Mw=249,434, PDI=3.54, yield=85.6%).

### Synthetic Example 4

### 4-1. Synthesis of Monomer

### Synthesis of 5-norbornene-2-methylcinnamate

5-norbornene-2-methanol (15 g (grams), 0.121 mol) synthesized in Synthetic example 1, triethylamine (Aldrich, 61.2 g (grams), 0.605 mol) and 20 ml (milliliters) of THF were added to a 250 ml (milliliter) 2-neck flask, and then stirred in an ice-water bath at 0° C. (celsius). Cinnamoyl chloride (22.1 g (grams), 0.133 mol) was dissolved in 60 ml (milliliters) of THF at a room temperature, and then added dropwise to the reaction mixture using an additional flask. After 10 minutes, the reaction mixture was warmed to a room temperature, and then stirred for additional 1 hour. The reaction solution was diluted with ethyl acetate, and washed several times with water and NaHCO₃ through a separatory funnel, and then distilled under a reduced pressure to remove the used solvents. The resulting reaction solution was purified using a column chromatography (hexane:ethyl acetate=20:1) to obtain a final product (yield: 88%).

¹H-NMR (300 MHz, CDCl₃): δ7.71˜7.66 (dd, 1H), 7.53˜7.36 (m, 5H), 6.49˜6.42 (dd, 1H), 6.17˜5.98 (m, 2H), 4.10˜3.76 (m, 2H), 2.94˜2.75 (m, 2H), 2.45 (m, 1H), 1.91˜1.83 (m, 1H), 1.48˜1.16 (m, 2H), 0.59 (m, 1H)

### 4-2. Synthesis of Polymer

### Polymerization of 5-norbornene-2-methylcinnamate

5 g (grams) (19.66 mmol) of 5-norbornene-2-methylcinnamate and 5 ml (milliliters) of a purified toluene solvent were added to a 250 ml (milliliter) schlenk flask. 0.88 mg (milligrams) of Pd(OAc)₂, 1.1 mg (milligrams) of tricyclohexylphosphine and 6.30 mg (milligrams) of dimethylanilinium tetrakis(pentafluorophenyl)borate that were previously dissolved in 1 ml (milliliter) of dichloromethane as a catalyst were added to the flask, and reacted at 40° C. (celsius) for 18 hours while stirring.

After the 18 hour reaction time, the reaction mixture was added to excessive ethanol to obtain a white polymer precipitate. The precipitate was percolated through a glass funnel to recover the polymer precipitate. The recovered polymer precipitate was dried at 65° C. (celsius) for 24 hours in a vacuum oven to obtain 1.6 g (grams) of a polymer 5-norbornene-2-methylcinnamate (Mw=703,000, PDI=2.0, yield=32%).

### Synthetic Example 5

### 5-1. Synthesis of Monomer

### Synthesis of 4-hydroxy methylcinnamate

4-hydroxy cinnamic acid (Aldrich, 20 g (grams), 0.122 mol) was dissolved in 120 ml (milliliters) of methanol at a room temperature, and 2 ml (milliliters) of sulfuric acid was added to the resulting mixture. The resulting reaction mixture was refluxed at 65° C. (celsius) for 5 hours, cooled, and the excessive methanol remnant was removed from the reaction mixture under a reduced pressure to obtain a red solid product. The red solid product was extracted with a large amount of ethyl acetate, washed with an aqueous NaHCO₃ solution, dried over anhydrous MgSO₄, and then filtered to remove of the used solvents using a rotary evaporator, thus to obtain 20.63 g (grams) of a red solid product. (yield: 95%).

¹H-NMR (400 MHz, acetone d₆): δ7.58˜7.62 (d, 1H), 7.53˜7.55 (dd, 2H), 6.88˜6.91 (dd, 2H), 6.32˜6.36 (d, 1H), 3.70 (s, 3H)

### Synthesis of (methyl cinnamate)-5-norbornene-2-carboxylate

Norbornene carboxylic acid (Aldrich, 11 g (grams), 79.64 mmol), 4-hydroxy methyl-cinnamate (12.9 g (grams), 72.4 mmol) synthesized in the Example 5-1,1-(3-dimethylaminopropyl)-3-ethylcarbodimide hydrochloride (EDC Aldrich, 22.2 g (grams), 115.84 mmol) and 1-hydroxybenzotriazole hydrate (HOBT, Aldrich, 14.7 g (grams), 108.6 mmol) were put into a 250 ml (milliliter) 2-neck flask, and dissolved in 100 ml (milliliters) of DMF at a room temperature. The resulting mixture was cooled to a temperature of 0° C. (celsius), and triethylamine (Aldrich, 50 ml (milliliters), 362 mmol) was added dropwise to the mixture. The resulting mixture was warmed to a room temperature for 3 hours. When the reaction is completed after the 3 hour reaction, the reaction mixture was extracted with a large amount of ethyl acetate. The extracted reaction mixture was washed with an aqueous NaHCO₃ solution, dried over anhydrous MgSO₄, and dried to remove off the solvents using a rotary evaporator, thus to obtain a yellow solid product. The yellow solid product was purified with a column chromatography (hexane:ethyl acetate=6:1) to obtain a pure product (yield: 60%).

¹H-NMR (300 MHz, CDCl₃): δ7.64˜7.69 (dd, 1H), 7.50˜7.53 (dd, 2H), 7.05˜7.14 (dd, 2H), 6.36˜6.43 (dd, 1H), 6.06˜6.27 (m, 2H), 3.80 (s, 3H), 2.99˜3.39 (m, 3H), 2.01 (m, 1H), 1.35˜1.60 (m, 3H)

### 5-2. Synthesis of Polymer

### Polymerization of (methyl cinnamate)-5-norbornene-2-carboxylate

3 g (grams) (10.06 mmol) of a monomer (methyl cinnamate)-5-norbornene-2-carboxylate and 7 ml (milliliters) of a purified toluene solvent were added to a 250 ml (milliliter) schlenk flask. 0.98 mg (milligrams) of Pd(OAc)₂, 1.13 mg (milligrams) of tricyclohexylphosphine and 6.4 mg (milligrams) of dimethylanilinium tetrakis (pentafluorophenyl)borate that were previously dissolved in 1 ml (milliliter) of dichloromethane as a catalyst were added to the flask, and reacted at 90° C. (celsius) for 5 hours while stirring.

After the 5 hour reaction time, the resulting reaction mixture was added to excessive ethanol to obtain a white polymer precipitate. The precipitate was percolated through a glass funnel to recover the polymer precipitate. The recovered polymer precipitate was dried at 65° C. (celsius) for 24 hours in a vacuum oven to obtain 1.36 g (grams) of a polymer (methyl cinnamate)-5-norbornene-2-carboxylate (Mw=289,000, PDI=2.76, yield=45%).

### Synthetic Example 6

### 6-1. Synthesis of Monomer

### Synthesis of 6-(4-oxy methyl cinnamate)hexanol

4-hydroxy methylcinnamate (8 g (grams), 44.9 mmol) synthesized in the Synthetic example 5, NaOCH₃ (Aldrich, 2.4 g (grams), 44.9 mmol) and NaI (270 mg (milligrams), catalytic amount) were put into a 250 ml (milliliter) 2-neck flask, and dissolved in 100 ml (milliliters) of dimethylacetamide at a room temperature. The resulting mixture was stirred for 1 hour, and chlorohexanol (Aldrich, 6 ml (milliliters), 44.9 mmol) was added to the mixture, and refluxed at 100° C. (celsius) for 2 days. When the reaction is completed after the overnight, the reaction mixture was cooled to a mom temperature, and the used solvents were then removed. Then, the generated solids were dissolved in a large amount of methanol at a room temperature, and the undissolved solids were removed. Then, the used solvents were removed from the mixture solution under a reduced pressure to obtain 8.4 g (grams) of a white solid product (yield: 67.2%).

¹H-NMR (400 MHz, CDCl₃): δ7.64˜7.68 (d, 1H), 7.48˜7.49 (dd, 2H), 6.89˜6.91 (dd, 2H), 6.30˜6.34 (d, 1H), 3.98˜4.02 (t, 2H), 3.81 (s, 3H), 3.67˜3.70 (t, 2H), 1.46˜1.84 (m, 8H)

### Synthesis of 6-(4-oxy methyl cinnamate)hexyl-5-norbornene-2-carboxylate

Norbornene carboxylic acid (Aldrich, 5 g (grams), 36.22 mmol), 6-(4-oxy methyl cinnamate)hexanol (8.4 g (grams), 30.18 mmol) synthesized in the Synthetic example 6-1, EDC (Aldrich, 9.26 g (grams), 48.29 mmol) and 1-hydroxybenzotriazole (HOBT, Aldrich, 6.12 g (grams), 45.27 mmol) were put into a 250 ml (milliliter) 2-neck flask, and dissolved in 70 ml (milliliters) of DMF at a room temperature. The resulting mixture was cooled to a temperature of 0° C. (celsius), and triethylamine (Aldrich, 21 ml (milliliters), 150.9 mmol) was added dropwise to the mixture. The resulting mixture was warmed to a room temperature, and reacted overnight. Then, when the reaction was completed after the overnight reaction, the reaction mixture was extracted with a large amount of ethyl acetate, washed with an aqueous NaHCO₃ solution, dried over anhydrous MgSO₄, and then filtered to remove the used solvents using a rotary evaporator, thus to obtain a yellow liquid product. The yellow liquid product was purified using a column chromatography (hexane:ethyl acetate=7:1) to obtain a pure product (yield: 70%).

¹H-NMR (400 MHz, CDCl₃): δ7.65˜7.69 (d, 1H), 7.47˜7.49 (dd, 2H), 6.90˜6.92 (dd, 2H), 6.31˜6.35 (d, 1H), 5.93˜6.22 (m, 2H), 3.99˜4.05 (tt, 4H), 3.81 (s, 3H), 2.92˜3.22 (m, 3H), 2.19 (m, 1H), 1.28˜1.85 (m, 11H)

### 6-2. Synthesis of Polymer

### Polymerization of 6-(4-oxy methyl cinnamate)hexyl-5-norbornene-2-carboxylate

5 g (grams) (12.55 mmol) of a monomer 6-(4-oxy methyl cinnamate)hexyl-5-norbornene-2-carboxylate and 5 ml (milliliters) of a purified toluene solvent were added to a 250 ml (milliliter) schlenk flask. 5.6 mg (milligrams) of Pd(OAc)₂, 7 mg (milligrams) of tricyclohexylphosphine and 40.2 mg (milligrams) of dimethylanilinium tetrakis (pentafluorophenyl)borate that were previously dissolved in 2 ml (milliliters) of dichloromethane as a catalyst were added to the flask; and reacted at 90° C. (celsius) for 18 hours while stirring.

After the 18 hour reaction time, the resulting reaction mixture was idled to excessive ethanol to obtain a white polymer precipitate. The precipitate was percolated through a glass funnel to recover the polymer precipitate. The recovered polymer precipitate was dried at 65° C. (celsius) for 24 hours in a vacuum oven to obtain 1.6 g (grams) of a polymer norbornene methylcinnamate (yield: 32%).

### Synthetic Example 7

### 7-1. Synthesis of Ring-Opening Polymer

### Synthesis of Polymer by Ring Opening Reaction of METCD

13.2 g (grams) (0.1 mol) of a monomer 8-methoxy-carbonyl tetracyclo[4,4,0,1^{2,5},1^{7,10}]dode-3-cene (METCD), 1.1 g (grams) (10 mmol) of monomer 1-octene and 60 ml (milliliters) of a purified toluene solvent were added to a 250 ml (milliliter) schlenk flask. 0.02 mmol of WCl₆ and 0.14 mmol of triethylaluminum that were previously dissolved in 1 ml (milliliter) of toluene as a catalyst were added to the flask, and reacted at 80° C. (celsius) for 18 hours while stirring. After the 18 hour reaction time, the resulting reaction mixture was added to excessive, acetone to obtain a polymer precipitate. The precipitate was percolated through a glass funnel to recover the polymer precipitate. The recovered polymer precipitate was dried at 70° C. (celsius) for 24 hours in a vacuum oven to obtain 11.8 g (grams) of an METCD ring-opening polymer (yield: 90%).

Hydrogenation of METCD Ring-Opening Polymer

15 g (grams) of the METCD ring opening polymer synthesized in the Synthetic example 7-1 and 150 ml (milliliters) of a purified toluene solvent were added to a 300 ml (milliliter) high-pressure reactor. 70 ppm (parts per million) of RuHCl(CO)(PCy₃)₃ catalyst was add to the reactor, a hydrogen pressure of 10 Mpa was applied to the reactor. Then, the resulting mixture was hydrogenated at 165° C. (celsius) for 4 hours while stirring. When the reaction was completed, the hydrogen pressure was removed, the reaction product was added to excessive ethanol to obtain a hydrogenated ring-opening polymer precipitate. The precipitate was percolated through a glass funnel to recover the polymer precipitate. The recovered polymer precipitate was dried at 70° C. (celsius) for 24 hours in a vacuum oven to obtain a hydrogenated ring-opening polymer (hydrogenation ratio: 99.7%).

### 7-2. Modification of Ring-Opening Polymer

Reduction of METCD Ring-Opening Polymer

The METCD ring-opening polymer (22 g (grams), 0.1 mol) synthesized in the Synthetic example 7-1 and 100 ml (milliliters) of THF were added to a 250 ml (milliliter) 2-neck flask, and the resulting mixture was stirred in an ice-water bath at 0° C. (celsius). Lithiumaluminumhydride (LiAlH₄, Aldrich, 42 g (grams), 0.11 mol) was dissolved in 10 ml (milliliters) of THF, and then added dropwise to the resulting mixture using an additional flask. After 2 hours, the resulting reaction mixture was warmed to a room temperature, and stirred for additional 3 hours. The reaction solution was precipitated in a large amount of ethanol to obtain 15.4 g (grams) of a ring-opening polymer in, which an ester functional group of METCD is reduced with alcohol (a TCD-CH₂OH ring-opening polymer) (yield: 70%).

Esterification of TCD-CH₂OH Ring-Opening Polymer (Introduction of Cinnamate Functional Group)

The synthesized TCD-CH₂OH ring-opening polymer (2.3 g (grams), 12.1 mmol), 4-methoxy cinnamic acid (Aldrich, 2.15 g (grams), 12.1 mmol), 1-(3-dimethylaminopropyl)-3-ethylcarbodimide hydrochloride (EDC Aldrich, 3.7 g (grams), 19.4 mmol) and 1-hydroxybenzotriazole hydrate (HOBT, Aldrich, 2.45 g (grams), 18.2 mmol) were added to a 250 ml (milliliter) 2-neck flask, and dissolved in 100 ml (milliliters) of DMF at a room temperature. Then triethylamine (Aldrich, 75 ml (milliliters), 0.605 mol) was added dropwise to the reaction solution, and then stirred for 3 hours. When the reaction was completed, the resulting reaction solution was precipitated in a large amount of ethanol to obtain a methoxy cinnamoyl group-engrafted ring-opening polymer (polymer modification conversion: 70%)

### Synthetic Example 8

### 8-1. Synthesis of Cyclo Olefin Copolymer

### Synthesis of Copolymer of Phenyl NB and Ethylene

5.1 g (grams) (30 mmol) of a monomer phenylnorbornene and 50 ml (milliliters) of a purified toluene solvent were added to a 250 ml (milliliter) dried batch reactor. The reactor was warmed to a temperature of 70° C. (celsius), and 0.3 μmol (micromoles) of a catalyst [PhCH(fluorenyl)(Cp)]ZrCl₂ and 1.2 mmol of methyl aluminoxane (MAO) were put into the reactor. Then, the resulting mixture was polymerized for 20 minutes while maintaining the reaction to an ethylene pressure of 75 psi. Then, the excessive ethylene pressure was removed, and the reaction solution was dropped into an aqueous excessive methanol/HCl solution (volume ratio: 1:1) to obtain a polymer precipitate. The precipitate was percolated through a glass funnel to recover the polymer precipitate. The recovered polymer precipitate was dried at 70° C. (celsius) for 24 hours in a vacuum oven to obtain a phenylnorbornene/ethylene copolymer (yield=4.5 g (grams), Mw=129,000, PDI=2.4).

### 8-2. Modification of Cyclo Olefin Copolymer

Friedel-Crafts Acylation

19.8 g (grams) (0.1 mol) of the phenylnorbornene/ethylene copolymer synthesized in the Synthetic example 8-1, and 150 ml (milliliters) of a purified CH₃CN solvent were ailed to a 250 ml (milliliter) 2-neck flask. 10 mol % Cu(OTf)₂ was added as a catalyst to the reaction solution, and the resulting reaction solution was reacted at 80° C. (celsius) for 8 hours. The reaction solution was then dropped into a large amount of methanol to precipitate a polymer, and the polymer was percolated to obtain a cinnamoyl functional group-engrafted phenylnorbornene/ethylene copolymer (polymer modification conversion: 65%).

### Example 1

### Preparation of Alignment Layer

2% by weight of the polymer, 5-norbornene-2-methyl-(4-methoxy cinnamate), synthesized in the Synthetic example 1 was dissolved in a solvent c-pentanone, and an 80 μm (micrometer)-thick polyethylene terephthalate substrate (SH71™, SK Korea) was coated with the resulting mixture using a roll coating method so that the resulting coating film can have a thickness of 1000 (Angstrom) after the dryness of the mixture. Then, the coating film was heated for 3 minutes in a oven at 80° C. (celsius) to remove the used solvents from an inner part of the coating film. Finally, the final coating film was formed.

The exposure was carried out using a high-pressure mercury lamp with intensity of 200 mW/cm² (mW/square centimeters) as a light source, and the coating film was endowed with an orientation to form an alignment layer by irradiating the coating film with polarized UV for 5 seconds using a wire-grid polarizer (Moxtek), the polarized UV being emitted vertically to a proceeding direction of the coating film.

Then, a polymerizable liquid crystal solution was prepared by dissolving a solid mixture of 95.0% by weight of UV-polymerizable cyano biphenyl acrylate and 5.0% by weight of a photoinitiator Irgacure 907 (Gba-Geigy, Switzerland) in toluene so that liquid crystal can be present at a content of 25 parts by weight, based on 100 parts by weight of the liquid crystal solution.

The prepared photoalignment layer was coated with the prepared liquid crystal solution, using a roll coating, so that the resulting coating film can have a thickness of 1 μm (micrometer) after the dryness of the liquid crystal solution. Then, the coating film was dried at 80° C. (celsius) for 2 minutes to orient liquid crystal molecules. A retardation film was prepared by fixing the orientation of the liquid crystal through the irradiation of the oriented liquid crystal film with non-polarized LTV using a high-pressure mercury lamp with intensity of 200 mW/cm² (mW/square centimeters) as a light source.

The orientation of the prepared retardation film was compared by measuring a light source between polarizers as transmittance, and a quantitative phase difference was measured using an Axoscan (commercially available from Axomatrix).

### Example 2

A retardation film was prepared in the same manner as in the Example 1, except that the polymer synthesized in the Synthetic example 2 was used instead of the polymer synthesized in the Synthetic example 1.

### Example 3

A retardation film was prepared in the same manner as in the Example 1, except that the polymer synthesized in the Synthetic example 3 was used instead of the polymer synthesized in the Synthetic example 1.

### Example 4

A retardation film was prepared in the same manner as in the Example 1, except that the polymer synthesized in the Synthetic example 4 was used instead of the polymer synthesized in the Synthetic example 1.

### Example 5

A retardation film was prepared in the same manner as in the Example 1, except that the polymer synthesized in the Synthetic example 5 was used instead of the polymer synthesized in the Synthetic example 1.

### Example 6

A retardation film was prepared in the same manner as in the Example 1, except that the polymer synthesized in the Synthetic example 6 was used instead of the polymer synthesized in the Synthetic example 1.

### Example 7

A retardation film was prepared in the same manner as in the Example 1, except that the polymer synthesized in the Synthetic example 7 was used instead of the polymer synthesized in the Synthetic example 1.

### Example 8

A retardation film was prepared in the same manner as in the Example 1, except that the polymer synthesized in the Synthetic example 8 was used instead of the polymer synthesized in the Synthetic example 1.

### Example 9

A retardation film was prepared in the same manner as in the Example 1, except that a photoalignment layer was irradiated with polarized UV at an angle of 1.5 degrees relative to a proceeding direction of a film.

### Example 10

A retardation film was prepared in the same manner as in the Example 1, except that a photoalignment layer was irradiated with polarized UV at an angle of 75 degrees relative to a proceeding direction of a film.

### Comparative Example 1

A retardation film was prepared in the same manner as in the Example 1, except that a compound represented by the following formula was used instead of the polymer synthesized in the Synthetic example 1.

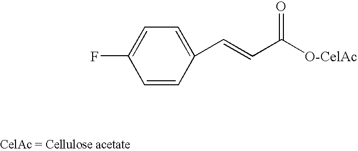

### Comparative Example 2

A retardation film was prepared in the same manner as in the Example 1, except that a compound represented by the following formula was used instead of the polymer synthesized in the Synthetic example 1.

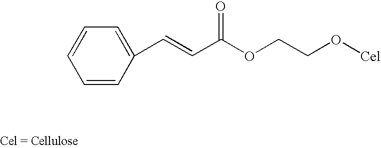

### Comparative Example 3

A retardation film was prepared in the same manner as in the Example 1, except that a compound represented by the following formula was used instead of the polymer synthesized in the Synthetic example 1.

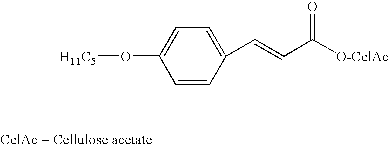

### Experimental Example 1

### Evaluation on Photoreactivity

### FT-IR Spectrum

Photoreactivities of the alignment layers were determined by observing FT-IR spectra of the liquid crystal alignment layers prepared in the Examples 1 to 6, 9 and 10, and the Comparative examples 1 to 3, and compared and evaluated on the basis of a value (E_{1/2}=20 mW/cm² (mW/square centimeters) t_{1/2}) calculated with the time (t_{1/2}) and the energy until the intensity of stretching males of C═C bonds in the Formulas a to c is reduced to a half of the initial intensity value by exposing the liquid crystal alignment layers to UV light (using a mercury lamp with intensity of 200 mW/cm² (mW/square centimeters)). The results are listed in the following Table 1.

In comparison of t_{1/2}, it was revealed that the time (t_{1/2}) of the retardation films of the Examples 1 to 6, 9 and 10 is shortened by approximately 1/20 to ¼, compared to the retardation films of the Comparative examples 1 to 3. Therefore, it was confirmed that the liquid crystal alignment layer according to one embodiment of the present invention has excellent photoreaction rate.

TABLE 1

| | T_{1/2 (min)} | E_{1/2 (J/cm}² _{(J/square centimeters))} |
|---|---|---|
| Example 1 | 1.0 | 1.1 |
| Example 2 | 1.1 | 1.2 |
| Example 3 | 1.2 | 1.2 |
| Example 4 | 1.0 | 1.2 |
| Example 5 | 1.1 | 1.3 |
| Example 6 | 1.0 | 1.2 |
| Example 9 | 1.0 | 1.1 |
| Example 10 | 1.0 | 1.1 |
| Comparative example 1 | 20.1 | 24.1 |
| Comparative example 2 | 9.3 | 11.2 |
| Comparative example 3 | 4.5 | 5.4 |

### Experimental Example 2

### Evaluation on Orientation (Evaluation on Light Leakage)

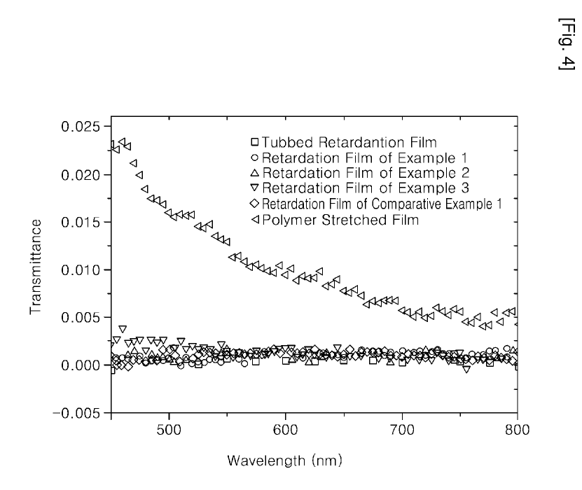

The orientation of the alignment layer was observed using a polarization microscope when the liquid crystal retardation films prepared in the Examples 1, 2 and 3 and the Comparative example 1 were disposed between two vertically arranged polarizers, and the results of the transmittances were shown in FIG. 4.

That is to say, the degree of light leakage was measured as transmittance, on the basis of a uniaxially stretched retardation film (Zeon, JP) male of cyclo olefin polymer (COP), by determining the extent to which the incident light is transmitted through the two polarizers and the retardation film after each of the liquid crystal retardation films prepared in the Examples 1, 2 and 3 and the Comparative example 1 was vertically disposed between the two vertically arranged polarizers and the incident light was allowed to transmit the polarizers and the retardation film, and the results of the transmittances were shown in FIG. 4.

Meanwhile, the rubbed alignment layer was measured for the degree of light leakage in the same manner as in the above context, and compared to the alignment layer according to one embodiment of the present invention. The rubbed alignment layer was prepared by rubbing a surface of a polyester substrate with a rayon rubbing cloth using a winding roll to endow the polyester substrate with an orientation. When the liquid crystal retardation film was prepared using the rubbing treatment, a stress was applied to a surface of the substrate in a certain direction while rubbing the surface of the substrate, and a structural change was caused, so that the liquid crystal can have its orientation. Accordingly, it was known that the conventional rubbed alignment layer has more excellent orientation than the photoalignment layer whose liquid crystal molecules are generally oriented by dimerizing photoreactive group since the conventional rubbed alignment layer was oriented in a uniform direction.

However, the retardation films according to one embodiment of the present invention prepared in the Examples 1 to 3 have uniform orientation directions of liquid crystal, as shown in FIG. 4. Therefore, according to an embodiment of the present invention, it is possible to prepare a retardation film whose orientation is compatible with that of the stretched retardation films made of cyclo olefin polymers, or rubbed retardation films with an improved performances and production yield since there is no factor that causes the absorption of dusts or the formation of scratches when the retardation film is subject to a rubbing process.

### Experimental Example 3

### Evaluation on Thermostability

### 3-1. Thermogravimetric Analysis (TGA)

Thermogravimetric analysis on the polymer 5-norbornene-2-methyl-(4-methoxy cinnamate) prepared in the Synthetic example 1 was carried out under the conditions (a nitrogen atmosphere, a temperature range from a room temperature to 600° C. (celsius), and an increased temperature rate of 10° C. (celsius)/min using a thermogravimetry analyzer (Model: TGA 2950, TA Instrument). As a result, it was revealed that the polymer 5-norbornene-2-methyl-(4-methoxy cinnamate) was stable at a temperature of 300° C. (celsius) or below, and gradually thermally degraded at temperature of 300° C. (celsius) or above.

### 3-2. Measurement of the Degree of Light Leakage According to the Temperature

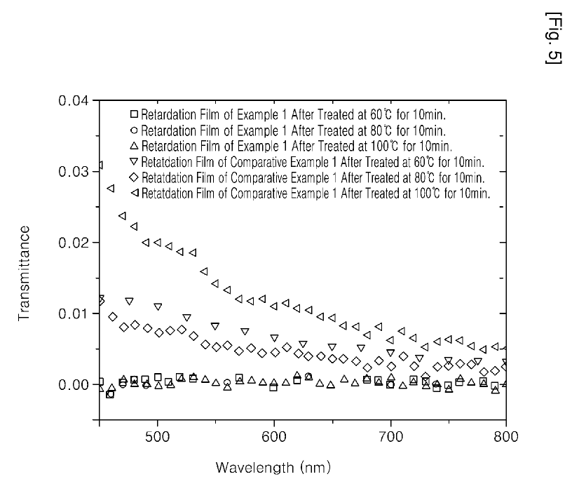

The alignment layers that were prepared in the Example 1 and Comparative example 1 was re-heated at the temperatures of 60, 80 and 100° C. (celsius), and the re-heated alignment layers were used to prepare retardation films in the same manner as in the Example 1. Then, orientations of the retardation films were observed using a polarization microscope. The results of the transmittances are shown in FIG. 5.

As seen from FIG. 5, it was revealed that the retardation film using the alignment layer of the Example 1 has a low transmittance since the liquid crystal is uniformly oriented regardless of the changes in temperature, but the retardation film using the alignment layer of the Comparative example 1 has poor orientation since its stability is lowered with an increasing temperature, which leads to the random orientation of liquid crystal.

### Experimental Example 4

### Measurement of Phase Difference Value

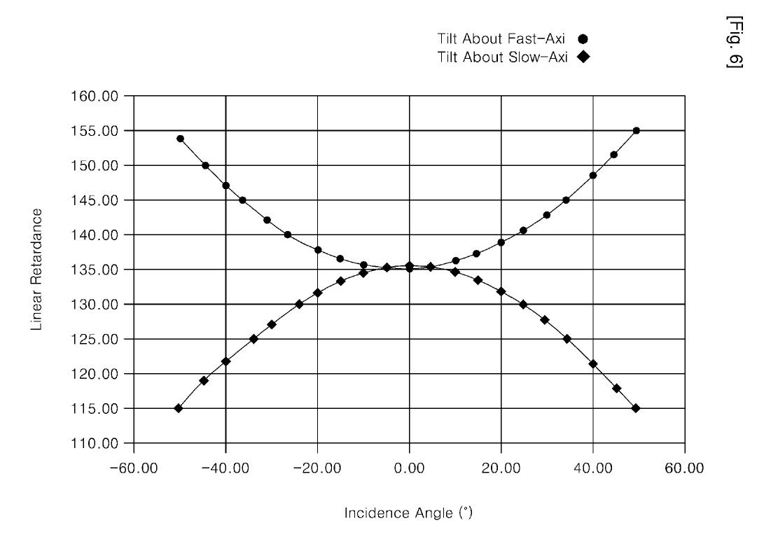

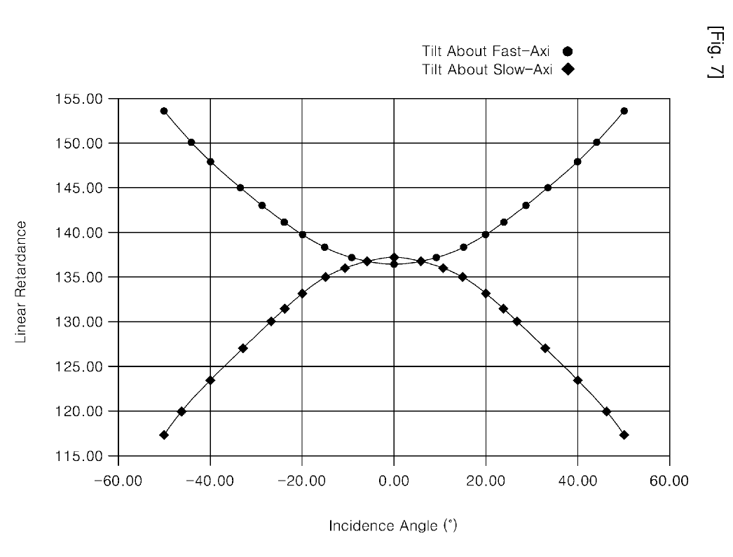

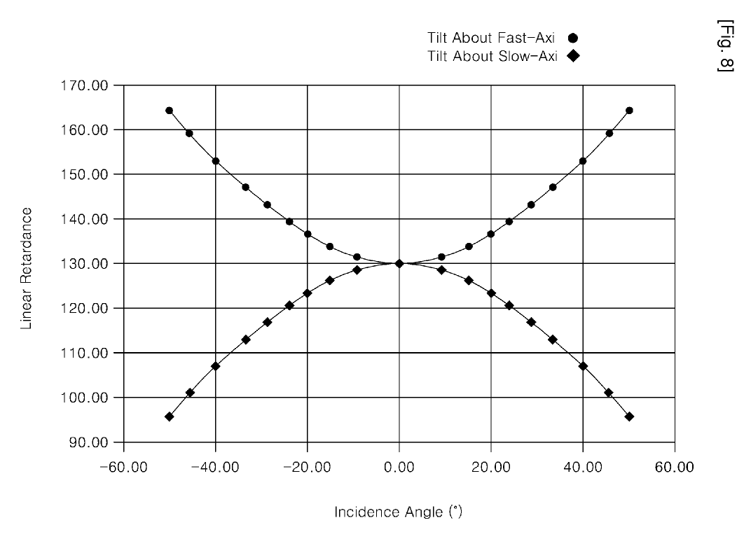

Phase differences of the retardation films prepared in the Examples 1, 2 and 3 were measured using an Axoscan (Axomatrix), and shown in FIGS. 6, 7 and 8, respectively. As seen from the graphs of FIGS. 6 to 8, it was revealed that the retardation films show uniform retardances that are symmetrical to each other in an incident angle range of −50.00 to +50.00°. From this result, it was seen that the retardation films of the Examples 1 to 3 were uniformly oriented in one direction.

1. A retardation film, comprising:
a substrate;
an alignment layer formed on the substrate and made of polymers having a polymerization unit derived from a compound represented by the following Formula 1; and
a liquid crystal layer formed on the alignment layer and made of nematic liquid crystal: 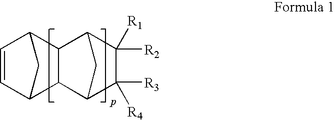
wherein, P is integer from 0 to 4,
at least one of R₁, R₂, R₃ and R₄ is a radical selected from the group consisting of the following Formulas a, b, and c, and
the rest of R₁, R₂, R₃ and R₄ are each independently selected from the group consisting of hydrogen; halogen; substituted or unsubstituted C1-20 alkyl, substituted or unsubstituted C2-20 alkenyl; substituted or unsubstituted C5-12 saturated or unsaturated cycloalkyl; substituted or unsubstituted C6-40 aryl; substituted or unsubstituted C7-15 aralkyl; substituted or unsubstituted C2-20 alkynyl; and a non-hydrocarbonaceous polar group including at least one element selected from the group consisting of oxygen, nitrogen, phosphorus, sulfur, silicon and boron, or
R₁, and R₂, or R₃ and R₄ may be bound to each other to form a C1-10 alkylidene group, or R₁, or R₂, may be bound to one of R₃ and R₄ to form C4-12 saturated or unsaturated cyclo alkyl or C6-24 aromatic compound, 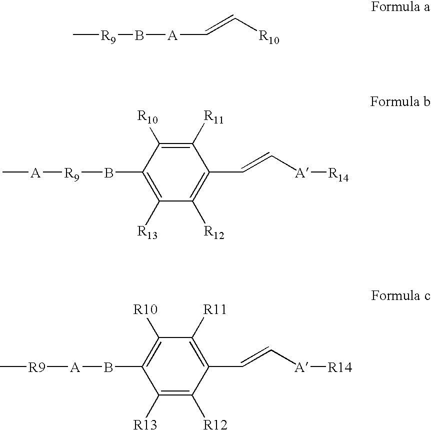
in the formulas a, b and c, A and A′ are each independently selected from the group consisting of substituted or unsubstituted C1-20 alkylene, carbonyl, carboxy, and substituted or unsubstituted C6-40 arylene;
B is oxygen, sulfur or —NH—;
R₉ is selected from the group consisting of a single bond, substituted or unsubstituted C1-20 alkylene, substituted or unsubstituted C2-20 alkenylene;
substituted or unsubstituted C5-12 saturated or unsaturated cyclo alkylene;
substituted or unsubstituted C6-40 arylene; substituted or unsubstituted C7-15 aralkylene; and substituted or unsubstituted C2-20 alkynylene;
R₁₀, R₁₁, R₁₂, R₁₃, and R₁₄ are each independently selected from the group consisting of substituted or unsubstituted C1-20 alkyl, substituted or unsubstituted C1-20 alkoxy, substituted or unsubstituted C6-30 aryloxy, substituted or unsubstituted C6-40 aryl, heteroaryl having 6 to 40 carbon atoms and including 14 to 16 group heteroelements, and substituted or unsubstituted C6-40 alkoxyaryl.

2. The retardation film of claim 1, wherein the polymerization unit derived from the Formula 1 is represented by the following Formula 1a, Formula 1b and/or Formula 1c: 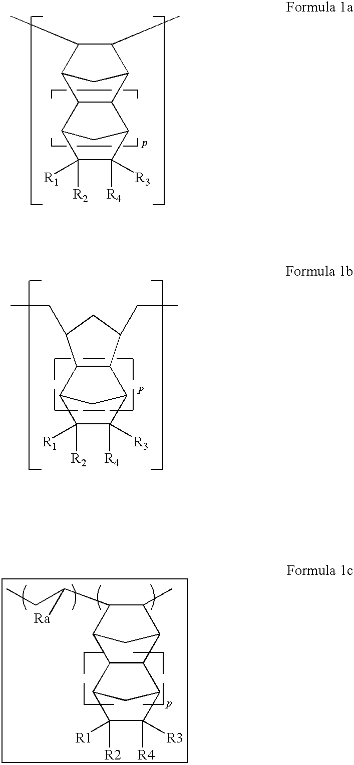
in the formulas 1a, 1b and 1c, p, R1, R2, R3 and R4 is defined as in the Formula 1, and
Ra in the Formula 1c represents hydrogen or C1-20 hydrocarbon group.

3. The retardation film of claim 1, wherein the non-hydrocarbonaceous polar group is selected from the group consisting of: —OR₆, —OC(O)OR₆, —R5OR₆, —R₅OC(O)OR₆, —C(O)OR₆, —R₅C(O)OR₆—C(O)R₆, —R₅C(O)R₆, —OC(O)R₆, —R₅OC(O)R₆, —(R₅O)_{q}—OR₆ (q is integer from 1 to 10), —(OR₅)_{q}—OR₆ (q is integer from 1 to 10), —C(O)—O—C(O)R₆, —R₅C(O)—O—C(O)R₆, —SR₆, —R₅SR₆, —SSR₆, —R₅SSR₆, —S(═O)R₆, —R₅S(═O)R₆, —R₅C(═S)R₆, —R₅C(═S)SR₆, —R₅SO₃R₆, —SO₃R₆, —R₅N═C═S, —N═C═S, —NCO, —R₅—NCO, —CN, —R₅CN, —NNC(═S)R₆, —R₅NNC(═S)R₆, —NO₂, —R₅NO₂, 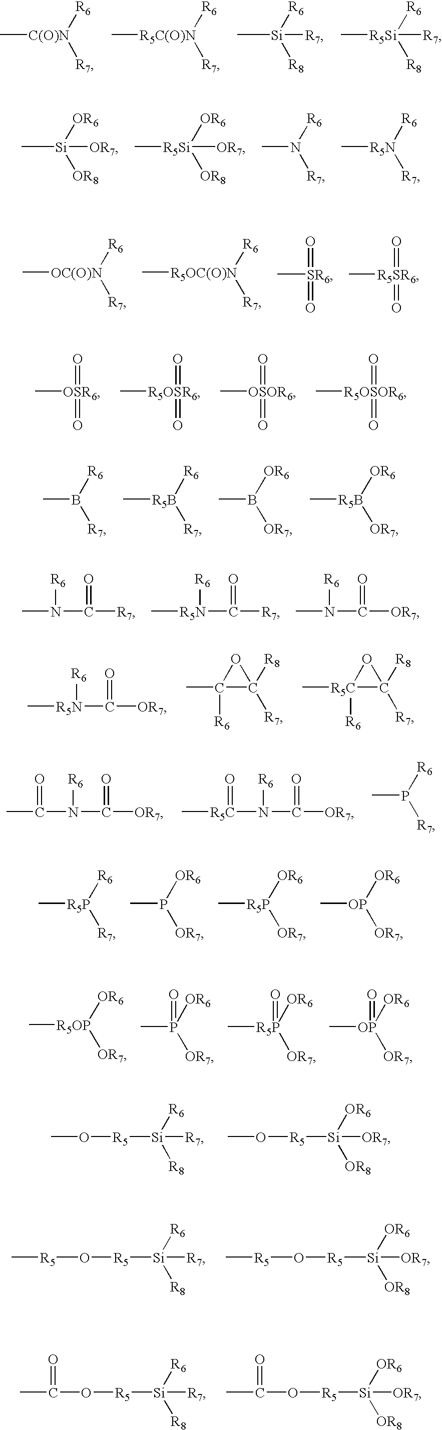 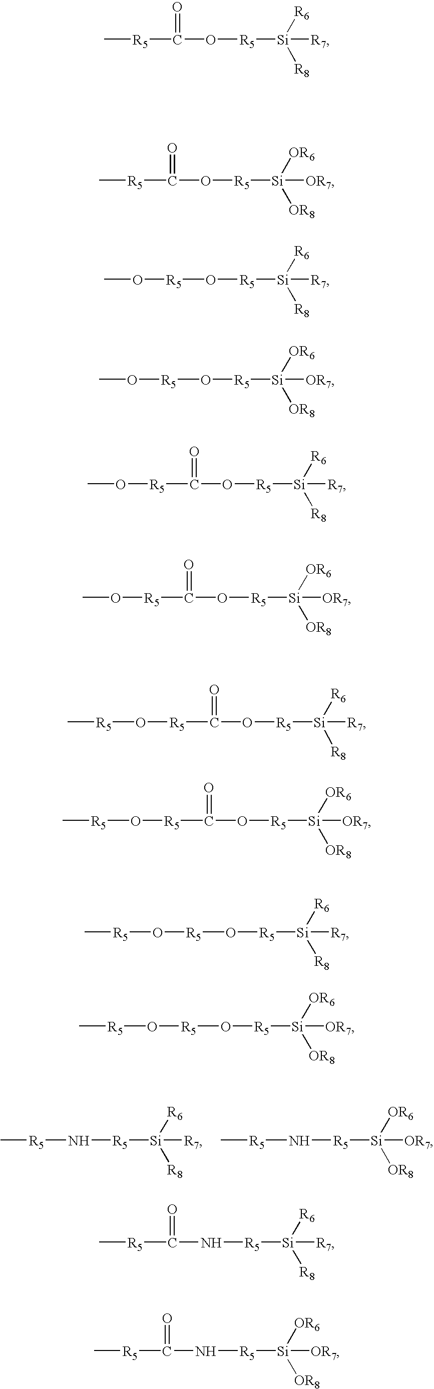 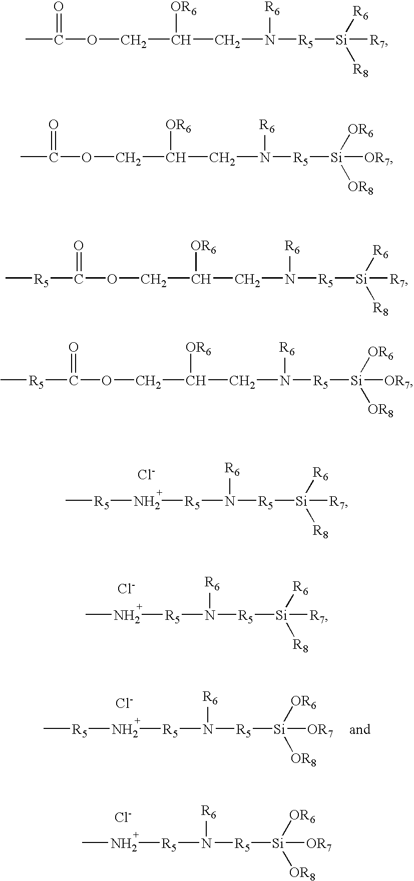
in the non-hydrocarbonaceous polar group, R₅ is selected from the group consisting of substituted or unsubstituted C1-20 alkyl, substituted or unsubstituted C2-20 alkenyl; substituted or unsubstituted C5-12 saturated or unsaturated cycloalkyl; substituted or unsubstituted C6-40 aryl; substituted or unsubstituted C7-15 aralkyl; and substituted or unsubstituted C2-20 alkynyl, and R₆, R₇, and R₈ are each independently selected from the group consisting of hydrogen; halogen; substituted or unsubstituted C1-20 alkyl, substituted or unsubstituted C2-20 alkenyl; substituted or unsubstituted C5-12 saturated or unsaturated cycloalkyl; substituted or unsubstituted C6-40 aryl; substituted or unsubstituted C7-15 aralkyl, and substituted or unsubstituted C2-20 alkynyl.

4. The retardation film of claim 1, wherein the polymer has a polymerization degree of 50 to 5000.

5. The retardation film of claim 1, wherein the polymer further comprises a polymerization repeating unit derived from the following Formula 3: 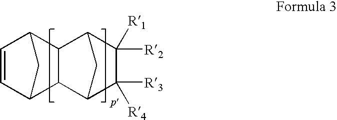
wherein, p′ is integer from 0 to 4, and
R′₁, R′₂, R′₃, and R′₄ are each independently selected from the group consisting of hydrogen; halogen; substituted or unsubstituted C1-20 alkyl, substituted or unsubstituted C2-20 alkenyl; substituted or unsubstituted C5-12 saturated or unsaturated cycloalkyl; substituted or unsubstituted C6-40 aryl;
substituted or unsubstituted C7-15 aralkyl; substituted or unsubstituted C2-20 alkynyl; and a non-hydrocarbonaceous polar group including at least one element selected from the group consisting of oxygen, nitrogen, phosphorus, sulfur, silicon and boron, or R′₁ and R′₂, or R′₃ and R′₄ may be bound to each other to form a C1-10 alkylidene group, or R′₁, or R′₂, may be bound to one of R′₃ and R′₄ to form C4-12 saturated or unsaturated cyclo alkyl or C6-24 aromatic compound.

6. The retardation film of claim 5, wherein the polymerization repeating unit derived from the Formula 3 is a polymerization repeating unit represented by the following Formulas 3a, 3b and/or 3c: 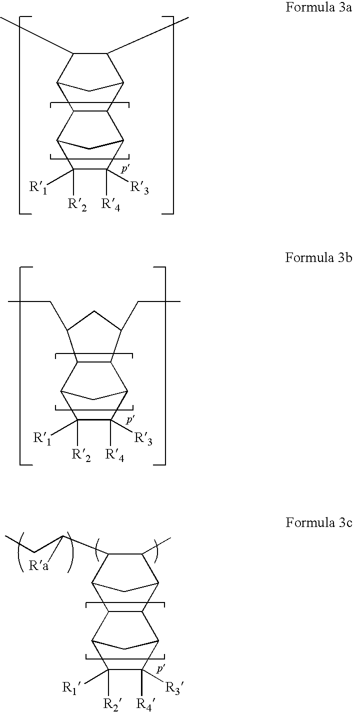
in the formulas 3a, 3b and 3c, p′ R′₁, R′₂, R′₃, and R′₄ is defined as in the Formula 3 and
R′a in the Formula 3c represents hydrogen or C1-20 hydrocarbon group.

7. The retardation film of claim 5, wherein the non-hydrocarbonaceous polar group is selected from the group consisting of —OR₆, —OC(O)OR₆, —R₅OR₆, —R₅OC(O)OR₆, —C(O)OR₆, —R₅C(O)OR₆, —C(O)R₆, —R₅C(O)R₆, —OC(O)R₆, —R₅OC(O)R₆, —(R₅O)_{q}—OR₆ (q is integer from 1 to 10), —(OR₅)_{q}—OR₆ (q is integer from 1 to 10), —C(O)—O—C(O)R₆, —R₅C(O)—O—C(O)R₆, —SR₆, —R₅SR₆, —SSR₆, —R₅SSR₆, —S(═O)R₆, —R₅S(═O)R₆, —R₅C(═S)R₆, —R₅C(═S)SR₆, —R₅SO₃R₆, —SO₃R₆, —R₅N═C═S, —NCO, —R₅—NCO, —CN, —R₅CN, —NNC(═S)R₆,
—R₅NNC(═S)R₆, —N═C═S, —NO₂, —R₅NO₂, 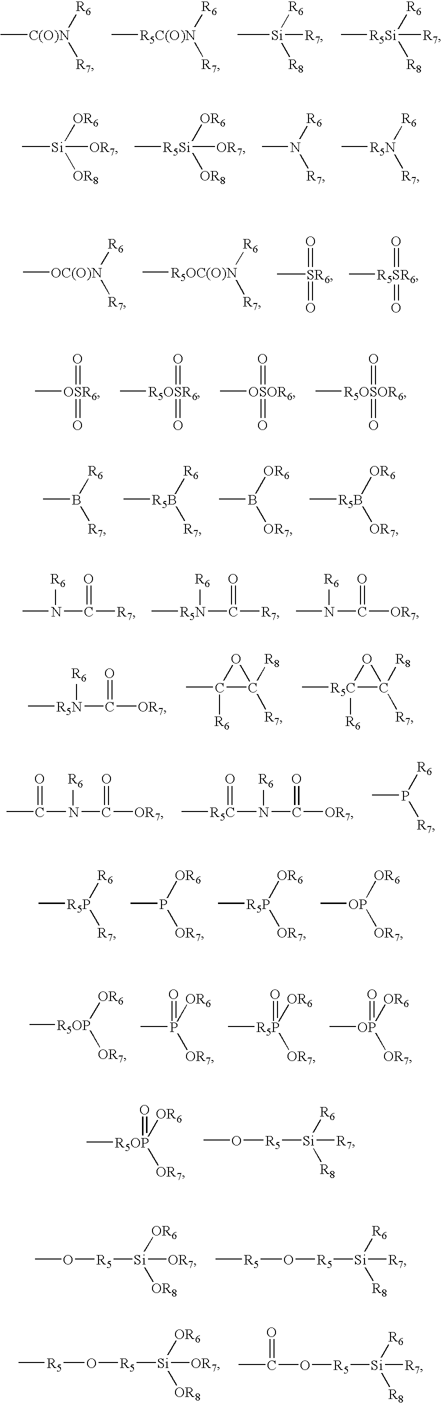 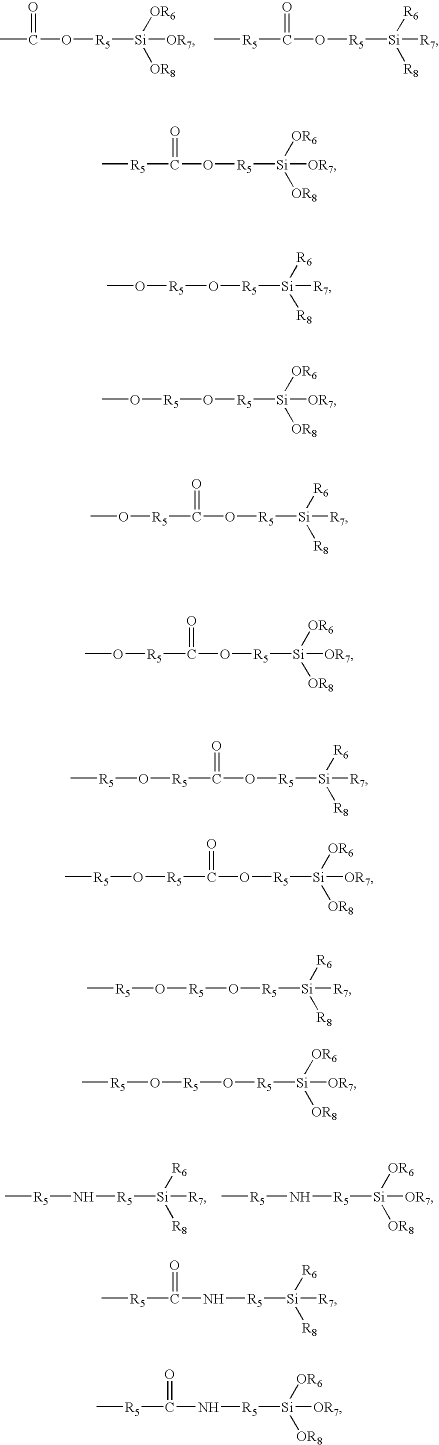 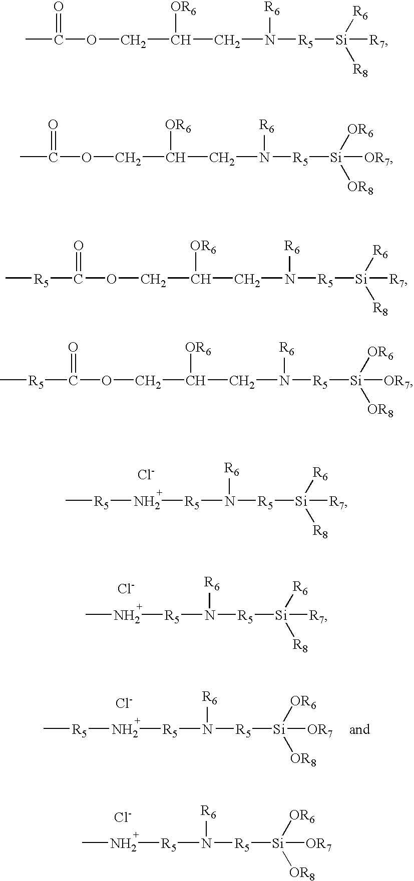
wherein, in non-hydrocarbonaceous polar group, R₅ may be selected from the group consisting of hydrogen; halogen; substituted or unsubstituted C1-20 alkyl, substituted or unsubstituted C2-20 alkenyl; substituted or unsubstituted C5-12 saturated or unsaturated cyclo alkyl; substituted or unsubstituted C6-40 aryl; substituted or unsubstituted C7-15 aralkyl; and substituted or unsubstituted C2-20 alkynyl, and
R₆, R₇, and R₈ are each independently selected from the group consisting of hydrogen; halogen; substituted or unsubstituted C1-20 alkyl, substituted or unsubstituted C2-20 alkenyl; substituted or unsubstituted C5-12 saturated or unsaturated cyclo alkyl; substituted or unsubstituted C6-40 aryl; substituted or unsubstituted C7-15 aralkyl; substituted or unsubstituted C2-20 alkynyl.

8. The retardation film of claim 5, wherein the polymer has 1 to 99 mol % of the polymerization repeating unit derived from the Formula 1 and 1 to 99 mol % of the polymerization repeating unit derived from the Formula 3.

9. The retardation film of claim 8, wherein the polymer has a polymerization degree of 50 to 5,000.

10. The retardation film of claim 1, wherein the alignment layer is aligned in a desired direction by irradiation of linearly polarized ultraviolet rays.

11. The retardation film of claim 10, wherein the linearly polarized ultraviolet rays have an intensity of 100 to 1000 mW/cm² (mW/square centimeters).

12. The retardation film of claim 1, wherein the alignment layer is aligned in an angle range spanning from a horizontal direction to vertical direction relative to a proceeding direction of the retardation film.

13. The retardation film of claim 1, wherein the nematic liquid crystal has a birefringence of 0.01 to 0.3.

14. The retardation film of claim 1, wherein the nematic liquid crystal is aligned in the same direction as that of the alignment layer.

15. The retardation film of claim 1, wherein the nematic liquid crystal includes acrylate group.

16. The retardation film of claim 1, wherein the retardation film has a phase difference of ¼λ (wavelength) or ½λ (wavelength).

17. The retardation film of claim 1, wherein the alignment layer and the liquid crystal layer are alternately stacked with each other.

18-38. (canceled)

39. The retardation film of claim 1, wherein the alignment layer is formed by drying at 70 to 300° (celsius) for 30 seconds to 60 minutes.

40. The retardation film of claim 1, wherein the alignment layer has a thickness of 800 to 2000° (Angstrom).

41. The retardation film of claim 2, wherein the polymer has a polymerization degree of 50 to 5000.

42. The retardation film of claim 2, wherein the polymer further comprises a polymerization repeating unit derived from the following Formula 3: 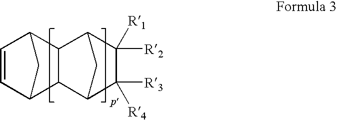
wherein, p′ is integer from 0 to 4, and
R′₁, R′₂, R′₃, and R′₄ are each independently selected from the group consisting of hydrogen; halogen; substituted or unsubstituted C1-20 alkyl, substituted or unsubstituted C2-20 alkenyl; substituted or unsubstituted C5-12 saturated or unsaturated cycloalkyl; substituted or unsubstituted C6-40 aryl; substituted or unsubstituted C7-15 aralkyl; substituted or unsubstituted C2-20 alkynyl; and a non-hydrocarbonaceous polar group including at least one element selected from the group consisting of oxygen, nitrogen, phosphorus, sulfur, silicon and boron, or
R′₁ and R′₂, or R′₃ and R′₄ may be bound to each other to form a C1-10 alkylidene group, or R′₁ or R′₂ may be bound to one of R′₃ and R′₄ to form C4-12 saturated or unsaturated cyclo alkyl or C6-24 aromatic compound.

43. The retardation film of claim 21, wherein the polymerization repeating unit derived from the Formula 3 is a polymerization repeating unit represented by the following Formulas 3a, 3b and/or 3c: 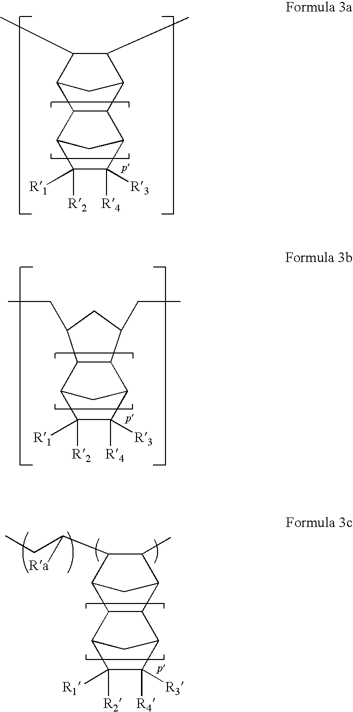
in the formulas 3a, 3b and 3c, p′, R′₁, R′₂, R′₃ and R′₄ is defined as in the Formula 3, and
R′a in the Formula 3c represents hydrogen or C1-20 hydrocarbon group.

44. The retardation film of claim 21, wherein the non-hydrocarbonaceous polar group is selected from the group consisting of —OR₆, —OC(O)OR₆, —R₅OR₆, —R₅OC(O)OR₆, —C(O)OR₆, —R₅C(O)OR₆, —C(O)R₆, —R₅C(O)R₆, —OC(O)R₆, —R₅OC(O)R₆, —(R₅O)_{q}—OR₆ (q is integer from 1 to 10), —(OR₅)_{q}—OR₆ (q is integer from 1 to 10), —C(O)—O—C(O)R₆, —R₅C(O)—O—C(O)R₆, —SR₆, —R₅SR₆, —SSR₆, —R₅SSR₆, —S(═O)R₆, —R₅S(═O)R₆, —R₅C(═S)R₆, —R₅C(═S)SR₆, —R₅SO₃R₆, —SO₃R₆, —R₅N═C═S, —NCO, —R₅—NCO, —CN, —R₅CN, —NNC(═S)R₆,
—R₅NNC(═S)R₆, —N═C═S, —NO₂, —R₅NO₂, 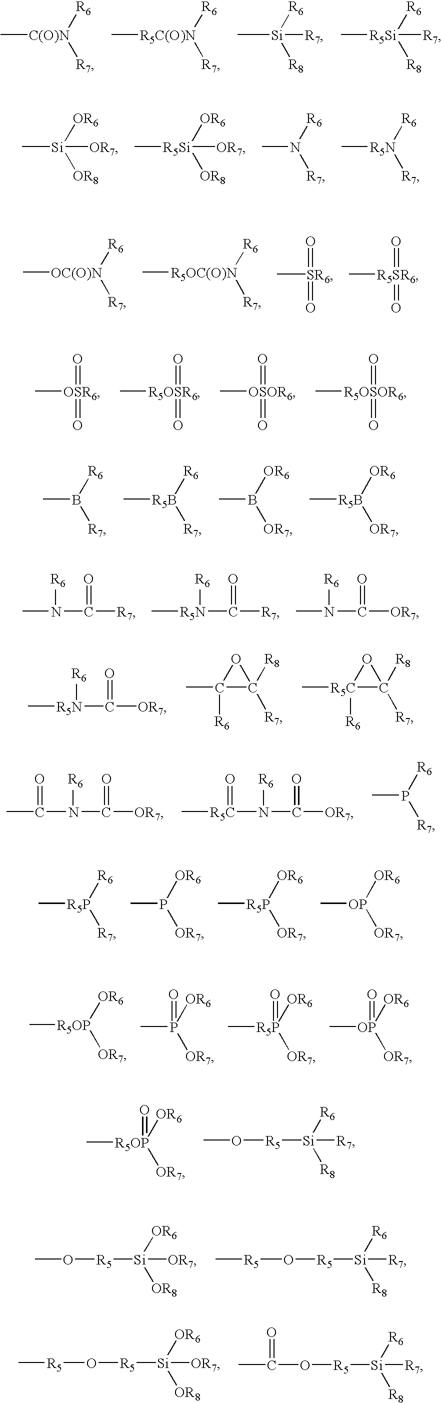 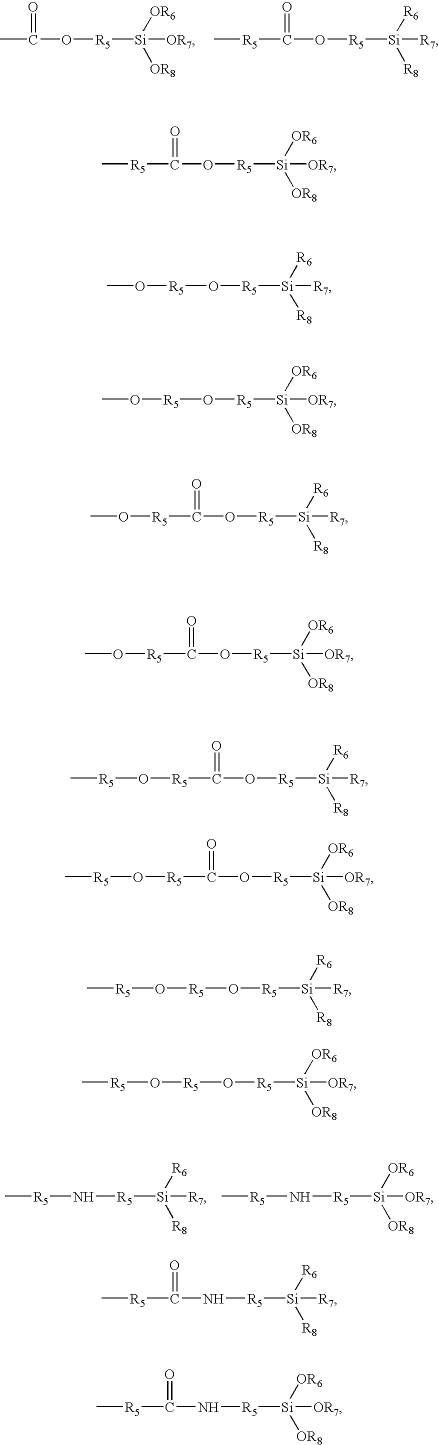 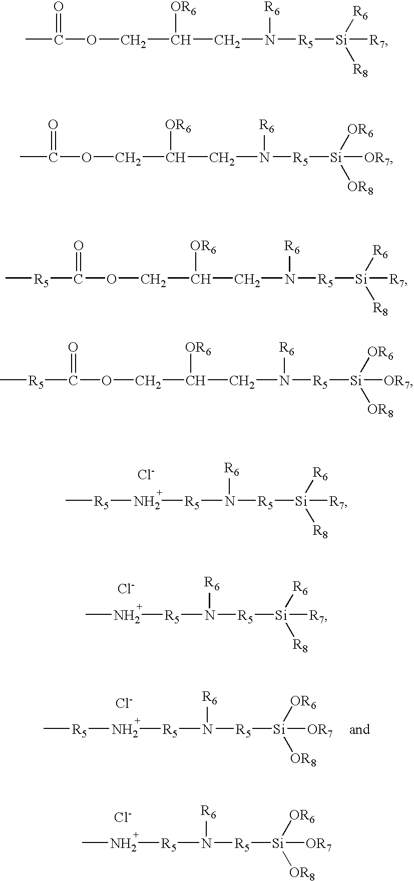
wherein, in non-hydrocarbonaceous polar group, R₅ may be selected from the group consisting of hydrogen; halogen; substituted or unsubstituted C1-20 alkyl, substituted or unsubstituted C2-20 alkenyl; substituted or unsubstituted C5-12 saturated or unsaturated cyclo alkyl; substituted or unsubstituted C6-40 aryl; substituted or unsubstituted C7-15 aralkyl; and substituted or unsubstituted C2-20 alkynyl, and
R₆, R₇, and R₈ are each independently selected from the group consisting of hydrogen; halogen; substituted or unsubstituted C1-20 alkyl, substituted or unsubstituted C2-20 alkenyl; substituted or unsubstituted C5-12 saturated or unsaturated cyclo alkyl; substituted or unsubstituted C6-40 aryl; substituted or unsubstituted C7-15 aralkyl; substituted or unsubstituted C2-20 alkynyl.

45. A polarizer comprising the retardation film defined in claim 1 and a polarizer film.
